(19) United States
(12) Patent Application Publication
(10) Pub. No.: US 2025/0208839 A1
(43) Pub. Date: Jun. 26, 2025

(54) Compiler for Mixed Precision in a Computational Graph

(71) Applicant: SambaNova Systems, Inc., Palo Alto, CA (US)

(72) Inventors: Mark William Gottscho, Mountain View, CA (US); Vidushi Goyal, Austin, TX (US); Han Wang, Ann Arbor, MI (US); Valentina Popescu, San Diego, CA (US); Yongning SHENG, San Jose, CA (US); Matthew William Ashcraft, San Carlos, CA (US)

(73) Assignee: SambaNova Systems, Inc., Palo Alto, CA (US)

(21) Appl. No.: 18/904,415

(22) Filed: Oct. 2, 2024

Related U.S. Application Data
(60) Provisional application No. 63/566,501, filed on Mar. 18, 2024.
(60) Provisional application No. 63/613,727, filed on Dec. 21, 2023.

(51) Int. Cl. G06F 8/41

(52) U.S. Cl. CPC G06F 8/41

(57) ABSTRACT

The disclosed technology relates to automatically optimizing the precision of data types in a computational graph, such as those used in machine learning and artificial intelligence applications. A representation of the computational graph is obtained. Nodes of the computational graph are assigned to one of three sets: a deny set, an allow set, or an infer set, based on a predefined policy. For nodes in the allow set, the method changes at least one of the input data precision, output data precision, or internal computation precision to a lower precision. For nodes in the infer set, the method propagates a data precision requirement from downstream nodes to upstream nodes. The method generates and stores computer instructions for executing the computational graph with the optimized precisions on one or more processors. This approach enhances performance and energy efficiency while maintaining model accuracy for the computational graph.

### REFERENCES

This application claims the benefit of U.S. Provisional Patent Application No. 63/566,501, filed on Mar. 18, 2024, entitled “Compiler for Mixed Precision in a Computational Graph,” and of U.S. Provisional Patent Application No. 63/613,727, filed on Dec. 21, 2023, entitled “Using Mixed Precision on RDUs.” Both aforementioned provisional applications are hereby incorporated by reference for any and all purposes.

The following are incorporated by reference for all purposes:
Prabhakar et al., “Plasticine: A Reconfigurable Architecture for Parallel Patterns,” ISCA '17, Jun. 24-28, 2017, Toronto, ON, Canada; and
Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018.

### BACKGROUND

### Technical Field

The technology disclosed relates to a compiler. In particular, it relates to a compiler that can automatically convert a computational graph to use mixed-precision data processing.

### Context

Accuracy, datatypes, precision, and range are related but distinct concepts. It is important to distinguish between them to avoid confusion.
Accuracy: The difference between a representation of a value and its “true” value.
Datatype: A defined representation of a value that is encoded using a finite number of bits.
Precision: The minimum possible difference between two distinct values with the same datatype.
Range: The difference between the largest and the smallest value that can be represented with the same datatype.

For example:
Accurate and precise: True value is 1; Representation of value: 1.0000000
Accurate and imprecise: True value is 1; Representation of value: 1
Inaccurate and precise: True value is 1; Representation of value: 100.784184
Inaccurate and imprecise: True value is 1; Representation of value: 100
Inaccurate and imprecise due to range (8-bit unsigned integer):
   True value is 10,000; Representation of value: 0×11111111=255

Given infinite precision, it would be possible to compute the result of any algebraic expression as a real value with true accuracy. But because numbers are represented in a computer using finite datatypes, they also have limited precision and range. It turns out in the general case that evaluating an algebraic expression with limited precision and/or range can produce inaccurate results.

For datatypes that are binary representation of integer numbers, precision may be the same for any bit-size representation, with the minimum possible difference always being ‘1’, but the number of bits determines the range for the datatype. For fixed point datatypes, the number of bits to the right of the radix determines the precision, that being 1/2^{r}, where r is the number of bits to the right of the radix. The number of bits to the left of the radix determines the range.

For floating-point datatypes, range and precision are determined by the number of bits allocated to the exponent and the fraction (or mantissa) in their binary representation. Several common floating point datatypes are provided below (although many other floating-point datatypes may be known to one of ordinary skill):

| | |
|---|---|
| • 32-bit IEEE single precision (fp32): | 1 bit sign, 8 bit exponent and |
| | 23 bit fraction |
| • 16-bit Brain Float (bfloat16 or bf16): | 1 bit sign, 8 bit exponent and |
| | 7 bit fraction |
| • 16-bit IEEE half-precision (fp16): | 1 bit sign, 5 bit exponent and |
| | 10 bit fraction |

The range of a floating point datatype refers to the difference between the maximum and minimum values that can be represented. This range is primarily influenced by the number of bits used for the exponent. For instance, the 32-bit IEEE single precision floating point format (fp32) allocates 8 bits for the exponent, allowing the format to represent values between approximately 1.4×10⁻⁴⁵ and 3.4×10³⁸. The 16-bit Brain Float format (bfloat16) also uses 8 bits for the exponent, providing a similar range but with less precision due to fewer bits being allocated to the fraction.

This precision for floating-point datatypes is determined by the number of bits used for the fraction, but it is different for different exponent values. For example, fp32 uses 23 bits for the fraction, allowing for a high degree of precision in representing values. Bfloat16 uses only 7 bits for the fraction, resulting in lower precision. When the exponent has a decoded value of 0, the precision of fp32 is about 0.00000011920928955 (2⁻²³) while the precision of bf16 is only 0.0078125 (2⁻⁷). But if the exponent has a decoded value of −126, the precision of fp32 is about 1.4×10⁻⁴⁵ while the precision of bf16 is only about 9.2×10⁻⁴¹.

The precision of a floating point datatype affects the accuracy of numerical computations for operations that require fine granularity, but the range can also affect accuracy. For example, a sum of a large number of values may exceed the maximum number that can be represented. The trade-off between range and precision is a consideration in selecting the appropriate floating point datatype for specific computational tasks, particularly in fields like machine learning and scientific computing where both large ranges and high precision may be required.

The amount of possible worst-case inaccuracy is a function of the expression. In many cases, it can be unbounded. It is important to map algorithms for implementing algebraic expressions with “numerically stable” behavior in the common case (even if they can still have unbounded error in the worst case).

Computing in higher precision costs more energy, bandwidth, and memory capacity. So, it makes sense to reduce precision of intermediate operators as long as it does not significantly degrade model accuracy. In power-limited chips like many processors today, reducing the energy of an operation can lead to increased throughput. However, if the precision is reduced too far in “the wrong places,” then the increased throughput can be offset by longer time to train, worse final accuracy, or even training non-convergence in a Machine Learning (ML) application.

### BRIEF DESCRIPTION OF THE DRAWINGS

The technology will be described with reference to the drawings, in which:

FIG. 1 shows an example of a mixed-precision computational graph.

FIG. 2 shows an example of a computational graph with operator-level mixed precision.

FIG. 3 illustrates an example dataflow graph with nodes and edges representing operations and datatypes flowing through the graph.

FIG. 4 shows an example of computational graph with mixed-precision datatypes, illustrating the conversion of datatypes for various operations of the dataflow graph of FIG. 3.

FIG. 5 shows an example of computational graph with mixed-precision datatypes, illustrating the conversion of datatypes for various operations of the dataflow graph of FIG. 3, based on a predefined aggressiveness indication.

FIG. 6 shows an example of computational graph with mixed-precision datatypes, illustrating the conversion of datatypes for various operations of the dataflow graph of FIG. 3, based on a different predefined aggressiveness indication.

FIG. 7A provides two representations of the same example computational graph with graphAMP disabled for a subgraph.

FIG. 7B illustrates a computational graph with mixed precision showing an example output of graphAMP for the example computational graph of FIG. 7A.

FIG. 8 shows a flowchart of an example implementation of a method computer-implemented method of transforming a dataflow graph to execute on one or more processors using mixed precision.

FIG. 9 illustrates an example system including a coarse-grained reconfigurable (CGR) processor, a host, and a memory.

FIG. 10 illustrates an example of a computer, including an input device, a processor, a storage device, and an output device.

FIG. 11 illustrates example details of a CGR architecture processor, including a top-level network (TLN) and two CGR arrays.

FIG. 12 illustrates an example CGR array, including an array of CGR units in an array-level network (ALN).

FIG. 13 illustrates an example of a pattern memory unit (PMU) and a pattern compute unit (PCU), which may be combined in a fused-control memory unit (FCMU).

FIG. 14 is a block diagram of a compiler stack implementation suitable for generating a configuration file for a CGR processor.

FIG. 15 shows an example user program in an example first stage of the compiler stack.

FIG. 16 shows the example user program in an example second stage of the compiler stack.

FIG. 17 shows the example user program in an example third stage of the compiler stack.

FIG. 18 shows the example user program in an example fourth stage of the compiler stack.

FIG. 19 shows an example logical computation graph and an example physical layout of the user program.

In the figures, like reference numbers may indicate functionally similar elements. The systems and methods illustrated in the figures, and described in the Detailed Description below, may be arranged and designed in a wide variety of different implementations. Neither the figures nor the Detailed Description are intended to limit the scope of the claims. Instead, they merely represent examples of different implementations of the disclosed technology.

### DETAILED DESCRIPTION

Traditional compilers translate human-readable computer source code into machine code that can be executed on a Von Neumann computer architecture. In this architecture, a processor serially executes instructions in one or more threads of software code. The architecture is static, and the compiler does not determine how execution of the instructions is pipelined, or which processor or memory takes care of which thread. Thread execution is asynchronous, and safe exchange of data between parallel threads is not supported.

High-level programs for machine learning (ML) and artificial intelligence (AI) may require massively parallel computations, where many parallel and interdependent threads (metapipelines) exchange data. Such programs are ill-suited for execution on Von Neumann computers. They require architectures that are optimized for parallel processing, such as coarse-grained reconfigurable (CGR) architectures (CGRAs) or graphic processing units (GPUs). They also utilize extensive computational resources to process large datasets and perform complex calculations. Traditional methods for executing these tasks typically rely on high-precision data types, such as 32-bit floating point (fp32), to ensure accuracy. However, the use of high-precision data types significantly increases the computational load, energy consumption, and memory requirements, which can limit the performance and scalability of ML models, especially on power-limited hardware platforms.

Existing solutions have attempted to address these challenges by implementing mixed-precision techniques, which combine high-precision and low-precision data types within the same computational graph. These approaches aim to reduce the computational burden and energy consumption while maintaining acceptable levels of accuracy. Current mixed-precision methods require manual intervention by the user to specify which operators use lower precision. This manual process can be tedious, error-prone, and may not fully exploit the potential performance gains. Additionally, these methods may not account for the broader context of the computational graph, leading to suboptimal precision adjustments that can negatively impact model accuracy.

The disclosed technology introduces a novel graph-level automatic mixed-precision (graphAMP) technique designed to optimize the floating point data types used in a computational graph, such as an artificial neural network. This method can automatically adjust the precision of data types across the entire computational graph, considering the context and connections between nodes to make informed decisions. By categorizing operations into three disjoint sets—deny set, allow set, and infer set—the technique ensures that numerically sensitive operations maintain high precision, while numerically stable operations can be downcast to lower precision. This approach not only simplifies the process for users but also enhances performance and energy efficiency without compromising overall model accuracy. GraphAMP can be applied to both training and inference phases of neural networks, as well as other types of computational graphs, making it a versatile solution for various applications.

### Terminology

As used herein, the phrase one of should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives such as first, second, and third, to describe an object, merely refers to different instances or classes of the object and does not imply any ranking or sequence.

The term coupled is used in an operational sense and is not limited to a direct or an indirect coupling. “Coupled to” is generally used in the sense of directly coupled, whereas “coupled with” is generally used in the sense of directly or indirectly coupled. “Coupled” in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term connected is used to indicate a direct connection, such as electrical, optical, electromagnetic, or mechanical, between the things that are connected, without any intervening things or devices.

The term configured (to perform a task or tasks) is a broad recitation of structure and can be interpreted to mean “having circuitry that” performs the task or tasks during operation. As such, the described item can be configured to perform the task even when the unit/circuit/component is not currently on or active. In general, the circuitry that forms the structure corresponding to “configured to” may include hardware circuits, and may further be controlled by switches, fuses, bond wires, metal masks, firmware, and/or software. Similarly, myriad items may be described as performing a task or tasks, for convenience in the description. Such descriptions should be interpreted as including the phrase “configured to.” Reciting an item that is configured to perform one or more tasks is expressly intended not to invoke 35 U.S.C. 112, paragraph (f) interpretation for that unit/circuit/component. More generally, the recitation of any element is expressly intended not to invoke 35 U.S.C. § 112, paragraph (f) interpretation for that element unless the language “means for” or “step for” is specifically recited.

As used herein, the term based on is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase “based on” is thus synonymous with the phrase “based at least in part on.”

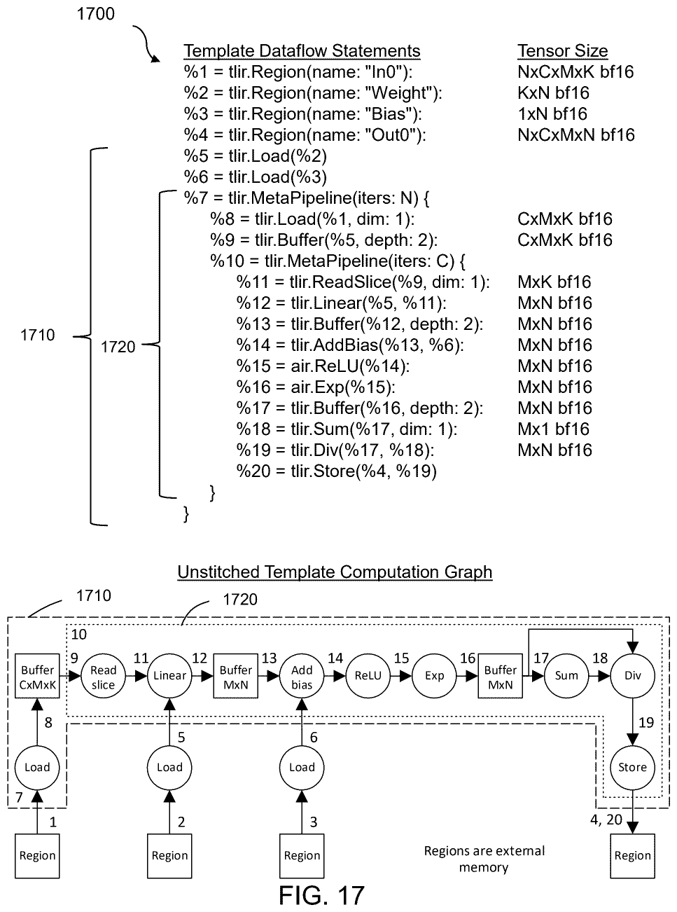

The following terms or acronyms used herein are defined at least in part as follows:
AGCU—address generator (AG) and coalescing unit (CU).
AI—artificial intelligence.
AIR—arithmetic or algebraic intermediate representation.
ALN—array-level network.
Buffer—an intermediate storage of data.
CGR—coarse-grained reconfigurable. A property of, for example, a system, a processor, an architecture (see CGRA), an array, or a unit in an array. This property distinguishes such devices from field-programmable gate arrays (FPGAs), which can implement digital circuits at the gate level and are therefore fine-grained configurable.
CGRA—coarse-grained reconfigurable architecture. A data processor architecture that includes one or more arrays (CGR arrays) of CGR units.
Compiler—a translator that processes statements written in a programming language to machine language instructions for a computer processor. A compiler may include multiple stages to operate in multiple steps. Each stage may create or update an intermediate representation (IR) of the translated statements. Compiler stages are illustrated with reference to FIG. 17.
Computation graph or Dataflow graph—The terms are used as synonyms herein. Some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.
CGR unit—a circuit that can be configured and reconfigured to locally store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.
CU—coalescing unit.
Datapath—a collection of functional units that perform data processing operations. The functional units may include, for example, memory, multiplexers, ALUs, SIMDs, multipliers, registers, and buses.
FCMU—fused compute and memory unit—a circuit that includes both a memory unit and a compute unit.
Graph—a collection of nodes connected by edges. Nodes may represent various kinds of items or operations, dependent on the type of graph. Edges may represent relationships, directions, dependencies, or dataflow, for example.
IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
A logical CGR array or logical CGR unit—a CGR array or a CGR unit that is physically realizable, but that may not have been assigned to a physical CGR array or to a physical CGR unit on an IC.
Metapipeline—a subgraph of a computation graph that includes a producer operator providing its output as an input to a consumer operator to form a pipeline. A metapipelines may be nested within another metapipeline, that is, producer operators and consumer operators may include other metapipelines.
ML—machine learning.
PCU—pattern compute unit—a compute unit that can be configured to repetitively perform a sequence of operations.
PEF—processor-executable format—a file format suitable for configuring a configurable data processor.
Pipeline—a staggered flow of operations through a chain of pipeline stages. The operations may be executed in parallel and in a time-sliced fashion. Pipelining increases overall instruction throughput. CGR processors may include pipelines at various levels. For example, a compute unit may include a pipeline at the gate level to enable correct timing of gate-level operations in a synchronous logic implementation of the compute unit, and a metapipeline at the graph execution level (typically a sequence of logical operations that are to be repetitively executed) that enables correct timing and loop control of node-level operations of the configured graph. Gate-level pipelines are usually hard wired and unchangeable, whereas metapipelines are configured at the CGR processor, CGR array level, and/or GCR unit level.
Pipeline Stages—a pipeline is divided into stages that are coupled with one another to form a pipe topology.
PMU—pattern memory unit—a memory unit that can locally store data according to a programmed pattern.
PNR—place and route—the assignment of logical CGR units and associated processing/operations to physical CGR units in an array, and the configuration of communication paths between the physical CGR units.
RAIL—reconfigurable dataflow unit (RDU) abstract intermediate language.
CGR Array—an array of CGR units, coupled with each other through an array-level network (ALN), and coupled with external elements via a top-level network (TLN). A CGR array can physically implement the nodes and edges of a dataflow graph.
SIMD—single-instruction multiple-data—an arithmetic logic unit (ALU) that simultaneously performs a single programmable operation on multiple data elements delivering multiple output results.
TLIR—template library intermediate representation.
TLN—top-level network.

### Implementations

The architecture, configurability, and dataflow capabilities of an array of CGR units enable increased compute power that supports both parallel and pipelined computation. A CGR processor, which includes one or more CGR arrays (arrays of CGR units), can be programmed to simultaneously execute multiple independent and interdependent dataflow graphs. To enable simultaneous execution, the dataflow graphs may need to be distilled from a high-level program and translated to a configuration file for the CGR processor. A high-level program is source code written in programming languages like Spatial, Python, C++, and C, and may use computation libraries for scientific computing, ML, AI, and the like. The high-level program and referenced libraries can implement computing structures and algorithms of machine learning models like AlexNet, VGG Net, GoogleNet, ResNet, ResNext, RCNN, YOLO, SqueezeNet, SegNet, GAN, BERT, ELMO, USE, Transformer, and Transformer-XL.

Disclosed herein is a method for graph-level automatic mixed-precision (graphAMP) conversion for dataflow graphs, such as artificial neural networks (ANNs). A dataflow graph that has strong types on all the tensors and all the compute nodes that produce and consume those tensors is provided and graphAMP goes through that graph and automatically determines which parts may be performed at lower precision in a way that does not significantly impact the end-to-end accuracy. GraphAMP may be included in a compiler or may be used as a pre-processor for a compiler, depending on the implementation.

The method looks at the context of the nodes of the graph. That is to say, it looks at how the nodes are connected to each other to decide what data precision is appropriate for the inputs of a node, based on the data precision of its output, and then it can propagate those decisions though the graph. If the method detects a low-precision node, it knows that the nodes upstream of that low-precision can also be low-precision. The method can be controlled using various presets, and/or using direct control of individual nodes in the graph.

Various presets may be predefined as an indication of an aggressiveness for the method. For a given preset, every operator is assigned into one of three disjoint sets, a deny set, an allow set, and an infer set. Any number of presets may be defined, depending on the implementation. Custom presets may be created by a user in some cases.

For nodes in the deny set, the datatype (or precision) of the node is not changed. If the node was set up to have fp32 inputs and outputs, the compiler will create the node to have fp32 inputs and outputs. For nodes in the allow set, the compiler is allowed to override what was initially set for the node and make it in low precision or mixed precision. For nodes in the infer set, the output data type of an operator is propagated back to its input and/or compute type. This can be effective for some numerical neutral operations like reshape or transpose that do not truly do any numerical computation, but just rearrange the input data to create the output data. For the infer set, the compiler may simply match the datatype for the input of the node to whatever datatype the downstream node uses.

In one example, the allow set may be set up to include modes implementing a general matrix-multiply (GEMM) or similar function (e.g., basic matrix multiply or MatMul) as they can run some parts at a lower precision without much accuracy loss. But there are many other operators that are not suitable for the allow set. These may be put into the deny set so that the compiler honors what the programmer specified. A user may tag a particular node in the graph as being exempt from these rules, effectively forcing that particular node into the deny set. Thus, a user could say that in general, MatMuls should be run in mixed precision but tag a particular MatMul to operate in full precision. This may be invoked, for example, using a compiler flag.

In many cases, it may be safe to run an operation at low precision, but for certain layers in a graph that may not be true. It can be difficult to determine where lower/mixed precision can be used without impacting accuracy and the disclosed methods can provide machine learning engineers the ability to fine tune their graphs and do the research to find the right tradeoff between accuracy and performance.

This can be done with different precisions of any type of data, such as converting operations expecting 32-bit IEEE floating-point (fp32) data to a 16-bit floating-point format such as 16-bit brain floating-point (bfloat16 or bf16) or IEEE 16-bit floating-point (fp16), converting bf16 to an 8-bit floating-point format (fp8), or converting a 64-bit floating-point format to a 32-bit or 16-bit format. Some implementation may utilize different bit-precisions of fixed point or integer data.

While artificial neural network graphs are used as examples herein, the techniques described could be used for any type of computational graph. The techniques may be used statically, where the compiler generates a static configuration file (or binary code), which is then run by the target hardware. In other implementations, a just-in-time (JIT) compiler may be used to dynamically manage the conversion to mixed precision. This may be useful when the input data has an impact on what precision can be safely used.

In a JIT compiler the graph is analyzed, and certain nodes may be converted (or not) to mixed precision. The graph may then be run, and its results analyzed to determine if the precision should be modified. If so, the graph is recompiled using different adjustment of precision and run again. This process may be repeated as many times as is useful based on the graph and the input data. It may be used for training or inference/prediction. It can be used to minimize the time required to train the model. If the loss curve for the graph starts to saturate, recompiling the application in higher precision can be done to see if the loss curve can be reduced.

As an example, the first compilation may have all operators in the deny set, which is very conservative and means that graphAMP makes no changes to data precision in the graph. The error could then be measured and then the compiler feedback loop could try lowering the precision on some operators, run a few steps in the algorithm, and see what happens to accuracy. If the accuracy is still acceptable, it can keep the lowered precision or run another iteration with additional operators at a lower precision.

Taking a matrix multiply as an example, it may originally be set up for fp32 input and fp32 output. At a lower precision, it would be either bf16 input and fp32 output, or it could be bf16 input, accumulate internally in bf16, and output bf16. The version selected can depend on its context in the graph and how it is connected to other nodes. As the method traverses backwards through the graph, it may determine places where the input data is at a higher precision than is going to be used by the mixed-precision version of the node. A conversion node may be added to convert the data to the lower precision data type, or the conversion may be fused into the upstream operator.

It should also be noted that forward and backward nodes can be differentiated, and different policies can be used on them without tightly coupling them, which is different than many other approaches to this problem.

There are two overloaded definitions of mixed precision:
1. Model-level mixed precision: A mixed-precision graph has at least two distinct data types among its edges (tensors) and nodes (operators).
2. Operator-level mixed precision: A mixed-precision operator has at least two distinct data types among its inputs, internal computations, and outputs.

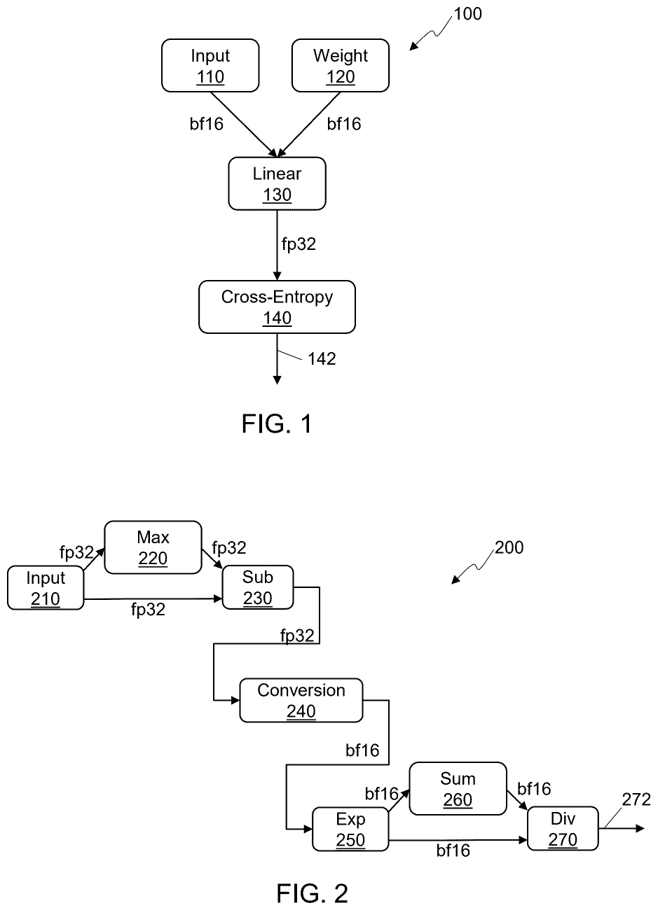

There are differences between graph-level and operator-level mixed precision. Graph-level mixed precision means that there are multiple distinct data types among the nodes and edges of the graph. FIG. 1 shows graph-level mixed precision, illustrating a computational graph 100 with at least two distinct data types among the edges and nodes. The graph 100 includes an input node 110 and a weight node 120, both utilizing the bf16 datatype. These nodes feed into a Linear operator node 130, which has inputs of the bf16 datatype and generates an output having a fp32 datatype. The output of the Linear operator 130 is then fed into a Cross-Entropy operator 140, which operates with fp32 precision. An output of the Cross-Entropy operator 140 is available on edge 142. This figure exemplifies how various parts of the computational graph 100 can use different datatypes, demonstrating the concept of mixed precision at the graph level.

FIG. 2 shows operator-level mixed precision for a Softmax function 200. Operator-level mixed precision means that the internal computation of the operator uses multiple datatypes having different data precision. The Softmax function 200 may be a component in a computational graph, designed to convert a vector of values into a probability distribution. The Softmax function 200 operates with mixed precision, utilizing both fp32 and bf16 datatypes for the internal calculations of the Softmax function 200. The Softmax function 200 includes several sub-components, each performing operations to achieve the final output.

The input node 210 of the Softmax function 200 receives an input tensor in the fp32 datatype. This input tensor is then processed by the Max function 220, which identifies the largest value within the input tensor. The Max function 220 operates using the fp32 datatype to ensure numerical stability and accuracy in identifying the maximum value.

Following the Max function 220, the Subtract function 230 subtracts the value of each element of the input tensor from maximum value. This operation is also performed using the fp32 datatype to maintain precision during the subtraction process. The output of the Subtract function 230 is then passed to the Conversion node 240.

The Conversion node 240 plays a role in the mixed-precision implementation of the Softmax function 200. The Conversion node 240 converts the output of the Subtract function 230 from the fp32 datatype to the bf16 datatype. This conversion reduces the computational load and energy consumption in subsequent operations.

Once the data is converted to the bf16 datatype, the Exponent function 250 processes the data. The Exponent function 250 calculates the exponential value of each element in the tensor (i.e., e where i represents an element of the tensor), using the bf16 datatype for both input and output. This operation benefits from the reduced precision, which accelerates computation while maintaining sufficient accuracy for the overall function.

The output of the Exponent function 250 is then aggregated by the Sum function 260, which adds up all the exponential values. The Sum function 260 operates using the bf16 datatype, leveraging the lower precision to enhance performance without significantly impacting the accuracy of the sum.

The Divide function 270 normalizes the exponential values by dividing each element by the sum calculated by the Sum function 260. The Divide function 270 also uses the bf16 datatype for the calculations, ensuring that the entire normalization process benefits from the performance improvements of mixed precision. The output of the Divide function 270 is the final result of the Softmax function 200, represented as a tensor in the bf16 datatype on edge 272.

In summary, the Softmax function 200 exemplifies operator-level mixed precision by combining fp32 and bf16 datatypes across the sub-components. The input node 210, Max function 220, and Subtract function 230 utilize fp32 for operations requiring high precision. The Conversion node 240, Exponent function 250, Sum function 260, and Divide function 270 leverage bf16 to optimize performance and energy efficiency while maintaining acceptable accuracy for the overall function.

FIG. 2 shows a Softmax function 200 which may have been hand-optimized to select datatypes for each node and edge within the function. But in many cases, a graph may be constructed using standard functions that default to using fp32 or some other high-precision datatype. GraphAMP can address both the graph level and the operator level to automatically determine where a lower-precision datatype may be used. For example, graphAMP can be run at the graph level and then at the level of each operator. It may even be run recursively used within each operator as it is broken down to its low-level components.

A graph containing mixed-precision operators is therefore also mixed precision, but the converse is not true. ML developers may sometimes use “mixed precision” to refer to a specific combination of fp32 and either bf16 or fp16. The term “mixed precision” as used herein, however, is a more general concept that can extend to any combination of datatypes having different data precision.

GraphAMP is a novel user-configurable graph-level automatic mixed-precision method that automatically adjusts the floating point data types used in a neural network model to improve performance without degrading overall model accuracy.

In contrast to past mixed-precision approaches, which typically work at the operator-level, this approach starts by defining three disjoint categories.
Numerically sensitive operations may be assigned to a “deny set.”
Numerically stable operations may be assigned to an “allow set.”
Numerically neutral operations may be assigned to an “infer set.”

A graphAMP preset defines how every operation in a dataflow graph library (e.g., a compiler intermediate representation or a neural network framework) is assigned to exactly one of these three disjoint sets. Example high level operations include but are not limited to MatMul, Linear, Softmax, LayerNorm, ReLU, Sigmoid, CrossEntropy, as well as many related gradient ops.

Multiple static presets that can range from “very conservative” (all operations are assumed to be numerically sensitive and go into the deny set) to “very aggressive” (all operations are assumed to be numerically stable and go into the allow set) may be defined. Users may also be able to define their own custom static presets, as long as each and every operation is mapped to exactly one set in the list of sets above. Note that in some implementations, only two of the sets may be explicitly defined for a given preset, with all remaining operations being assigned to the third set.

At least one implementation of graphAMP may work as follows.
deny set operations honor the data types that are originally assigned by the model programmer. (Typically, this may be the de facto neural network standard of 32-bit floating point, a.k.a. fp32.)
infer set operations can run in high precision (pure fp32) or low precision (pure bf16). GraphAMP is free to select either one depending on the surrounding graph context.
allow set operations always run in mixed precision (bf16 inputs and fp32 outputs) or low precision (pure bf16), depending on their graph context.

The method starts by assigning all of the nodes in the dataflow graph (i.e., operations) to one of the three sets based on a preset, or an aggressiveness indication, for that graph. The aggressiveness indication may be embedded in a representation of the dataflow graph, received from a user, retrieved from a configuration file for the compiler, or obtained using any other appropriate mechanism. For each preset aggressiveness indication, a list of operators for each of the three sets of operations may be obtained and used to assign each node of the graph to one of the three sets. The algorithm may start with the operation that generates the graph's output and determines a precision that should be used based on its assigned set and the rules listed above. It then propagates the operation's input precisions “upstream” (in the reverse dataflow direction) to the next level of operations of the graph (i.e., the next level of producers) and repeats the process. The method continues working in this reverse depth-first search pattern until all operations have been evaluated and their data types have been finalized according to the preset definition.

As a result, numerically sensitive operations get high precision inputs, which ensures good accuracy, while allowing numerically stable operations to run with lower precision inputs, thereby simultaneously improving performance and energy efficiency. Numerical neutral operations, which are neither stable nor sensitive operations, simply pass on the precision requirement of their downstream consumers (including transitive dependencies) to their producers. This behavior ensures that numerically sensitive downstream consumers do not lose accuracy due to upstream numerically neutral operations.

Additionally, the model programmer may override specific operation instances as being in the deny set (even if the operation type is in the allow set or infer set). This allows the programmer to tune the precision of specific neural network layers at the source code level while the method (potentially implemented within a neural network graph compiler) automatically adjusts the precision throughout the rest of the model to improve efficiency, power, and speed while maintaining enough accuracy for the model to operate accurately.

Some implementations may automatically learn which specific operation instances are numerically stable, sensitive, or neutral on a per-application and per-dataset basis. Given runtime feedback from statistics of operator inputs, the method (when implemented within a just-in-time compiler) can perform online adaptation to better fit the accuracy/performance characteristics of a model on a particular dataset.

This adaptive version of this method may start with all operation instances in the deny set. When running the model, if the statistics of an operation's operands-when measured at a particular checkpoint-show that reducing their precision would not harm overall model accuracy, that operation can be moved to the allow set or infer set and the model can be seamlessly recompiled and continue running. This can be repeated indefinitely until many operations have been converted to lower precision to achieve greater speed-up without sacrificing accuracy. If the accuracy degrades or as the dataset distribution drifts over time, then the algorithm can adaptively return specific operation instances back to the deny set to recover accuracy. This may be useful because the required precision of a particular dataflow graph operator depends on both its algebraic definition and its input data distribution (which is highly application-specific).

Thus, a method of transforming a dataflow graph to execute on one or more processors using mixed precision may include obtaining a representation of the dataflow graph and generating first computer instructions for the one or more processors to execute the dataflow graph as defined by the representation of the dataflow graph. It may then continue by obtaining a first set of tensors and executing the first computer instructions to process the first set of tensors while generating runtime statistics for at least a subset of the one or more nodes. It may then select a target node of the dataflow graph based on the runtime statistics and change at least one of a first datatype of an input of the target node, a second datatype of an output of the target node, or a third datatype of an internal calculation of the target node, to a changed datatype at a changed data precision before generating second computer instructions for the one or more processors to execute the dataflow graph including the changed data precision. A second set of tensors can then be obtained and the second computer instructions executed by the one or more processors to process the second set of tensors using the changed data precision.

New statistics may be generated during this process and used to select a new target node for data precision adjustment. Alternatively, the initial target node may be changed back to its original precision based on the new statistics. This process may be repeated for any number of sets of tensors to fine-tune the data precision of the dataflow graph. One example of statistics that could generated is to sample the tensors periodically, and find how much error would be introduced by lowering that compute node's precision, and then lower the precision if the error is below a threshold. Another example is speculatively and randomly perturb the precision of nodes in the network and measure what effect the change in precision has on the output loss vs a golden reference on the same input, and if the difference is small, then commit the speculative precision change.

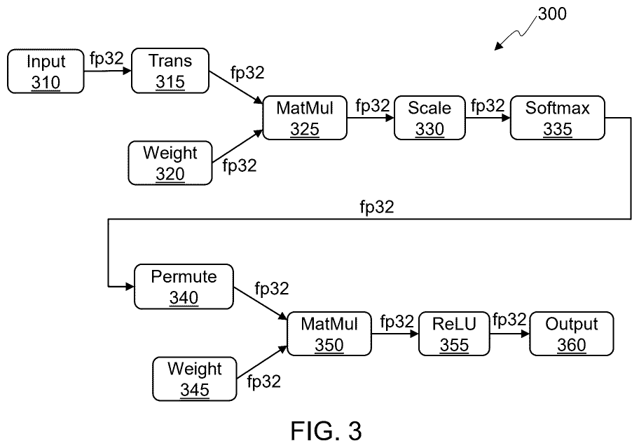

FIG. 3 illustrates an example dataflow graph 300 (or computational graph) with nodes and edges representing operations and datatypes flowing through the graph 300. Each node and edge are associated with a specific datatype, in this case, fp32, indicating 32-bit floating-point precision. The computational graph 300 can be used as an input to graphAMP.

An input node 310 receives data in fp32 format. This data is then passed to a transpose node 315, which also operates in fp32. The transposed data is then fed into a matrix multiplication (MatMul) node 325, which takes an additional input from a weight node 320, both in fp32 format. The output of the MatMul node 325 remains in fp32 and is passed to a scaling node 330, which also operates in fp32.

The scaled data is then processed by a SoftMax node 335, which outputs data in fp32. The output of the SoftMax node 335 is then fed into a permutation node 340, which continues to operate in fp32. The permuted data is then passed to another MatMul node 350, which takes an additional input from another weight node 345, both in fp32 format. The output of this MatMul node 350 remains in fp32 and is passed to a ReLU node 355, which also operates in fp32.

The final output of the ReLU node 355 is then passed to an output node 360, which produces the final result in fp32 format. The computational graph 300 illustrates the flow of data through various operations, all maintaining 32-bit floating-point precision, making the computational graph 300 a suitable input for graphAMP to optimize for mixed precision.

It should be noted that graph 300 also represents the output graph of graphAMP using graph 300 as its input if all operations are in the deny set. That is to say, if graphAMP is used on a graph with all operations in the deny set, graphAMP may make no changes to the graph.

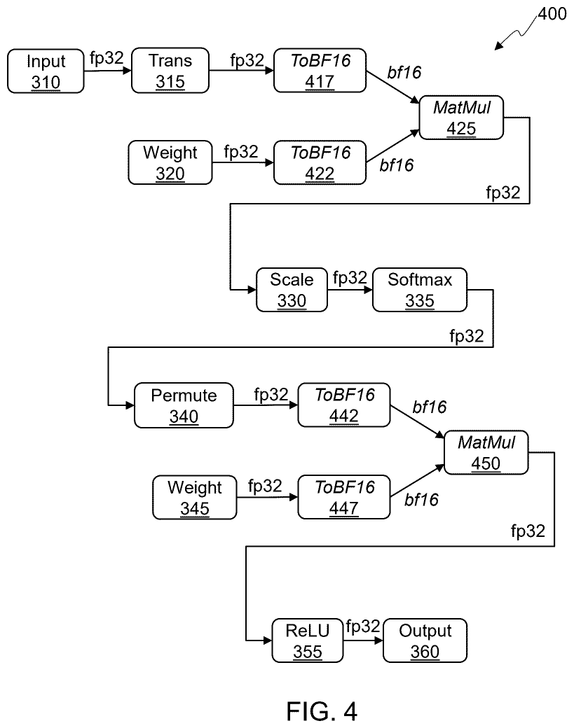

FIG. 4 shows an example of computational graph 400 with mixed-precision datatypes, illustrating the conversion of datatypes for various operations of the dataflow graph of FIG. 3. An implementation of graphAMP may be used to generate computer instructions representing the computational graph 400 from a representation of the computational graph 300 (or dataflow graph) shown in FIG. 3. GraphAMP may obtain a representation of the dataflow graph 300 in any form. The representation may be in the form of high-level computer code in a language such as, but not limited to, Python, JavaScript, Java, C, C++, or C#, and may use functions defined by one or more libraries, such as, but not limited to, PyTorch, TensorFlow, or libraries for a specific hardware architecture. The representation may alternatively take the form of a graphical representation of the dataflow graph, similar to what is shown in FIG. 3, or a textual description of the dataflow graph in a human language, such as English. Also note, that boundaries of graphs may be presented as any combination of input nodes, output nodes, input edges, and output edges, depending on the representation. Any type of representation of the dataflow graph may be used. The representation of the dataflow graph may be obtained by any appropriate method, including, but not limited to, reading a computer file, receiving the representation over a computer network, or interactively receiving the representation through a user interface.

The dataflow graph 300, as described above, includes one or more nodes 310-360 connected by one or more edges having a respective datatype with a respective precision representing dataflow in the dataflow graph 310-360. In the example graph 300, each edge uses an fp32 datatype with 32-bits of data precision. Note that some nodes, such as MatMul 325, have an output using the fp32 datatype, two inputs each using the fp32 datatype, and may include an internal calculation which may use the fp32 datatype or some other datatype. Other graphs used as an input for graphAMP may include a node using different datatypes for its input and output.

GraphAMP then evaluates the dataflow graph 300 to select a target node for data precision adjustment. This selection may be done in diverse ways in different implementations. The target node may be selected based on its function being numerically stable. It may be selected based on statistics generated for the nodes of the graph 300 during operation. It may be selected based on a list of functions that are allowed to be selected. GraphAMP may traverse the graph 300 from its output 360 in an upstream direction to find a node to use for the target node. Any suitable technique can be used to select the target node, but in the example shown, the output 360 and the ReLU 355 are not selected, so they are copied to the output dataflow graph 400 unchanged, along with their connecting edge.

In the example shown, MatMul (matrix multiply) 350 is selected as the target node, so the target node includes a multiply operation. Multiply operations are good candidates for mixed precision because multiplying two inputs of the same size generates an output that is twice as big as an input. GraphAMP changes at least one of a first datatype of an input of the target node, a second datatype of an output of the target node, or a third datatype of an internal calculation of the target node, to a changed datatype at a changed data precision. In the example shown, the datatype for the two inputs is changed from fp32 (a 32-bit datatype) to bf16 (a 16-bit datatype of the same type as fp32, i.e. a floating-point datatype, having half the data precision of the output datatype), changing the MatMul 350 node which expects to fp32 inputs, to a version of MatMul 450 that receives two bf16 inputs and generates an fp32 output, with MatMul 450 and the edge connecting it copied to the output graph 400. Thus, the datatype of the input of the target node is changed to have the changed datatype having a lower than the data precision of the output. Because of the characteristics of a multiply operation, this can be done with no appreciable reduction in accuracy. So, one way that a node using a multiply operation may be selected as a target node is to determine that the data precision of an input is greater than one half of the data precision of the output.

GraphAMP may then select a preceding node having its output connected to the input of the target node by an edge in the graph 300, such as Weight 345. GraphAMP may then insert a conversion node, ToBF16 447, between the preceding node, Weight 345, and the target node, MatMul 450, to convert the fp32 values provided at the output of Weight 345 into bf16 values to provide to the input of MatMul 450. That is to say, GraphAMP may insert a conversion node change a precision of data provided by the output of the preceding node having the first data precision provided by the output to the changed data precision before passing it to the input of the target node. The conversion node, ToBF16 447 is added to the output graph 400 and Weight 345 is copied to the output graph 400, along with their connecting edges.

GraphAMP may the proceed to traverse the input graph 300, adding a conversion node, ToBF16 442 between Permute 340 and the other input of MatMul 450 to the output graph 400 and copying Permute 340, Softmax 335, and Scale 330 with their associated edges to the output graph 400. It may then select MatMul 325 to be another target node, adding MatMul 425, with bf16 inputs instead of the fp32 inputs of MatMul 325, to the output graph 400. Conversion nodes, ToBF16 442 and ToBF16 417, may be added to the output graph 400 to convert the fp32 outputs of Weight 320 and Transpose 315, respectively, to bf16 to provide to the inputs of MatMul 425. Weight 320, Transpose 315, and Input 310 may then be copied along with their associated edges, to the output graph 400. The traversal of the input graph 300 may then be complete.

GraphAMP, or a compiler using an output of graphAMP as its input, then generates computer instructions for one or more processors to execute the dataflow graph 400 including the changed data precision. The computer instructions are then stored on a non-transitory computer-readable storage medium. The computer instructions may then be read from the non-transitory computer-readable storage medium by the one or more processors. They may also obtain one or more tensors and execute the computer instructions to process the one or more tensors as described by the dataflow graph 400 with the changed data precision. The execution of the computer instructions to process the one or more tensors as described by the dataflow graph 400 with changed data precision may be a part of training the dataflow graph 400 and the one or more tensors may be training data for the graph 400. At other times, the one or more tensors may be used to generate an output of the dataflow graph with changed data precision to make a prediction based on the one or more tensors.

In some implementations, graphAMP obtains an aggressiveness indication for the dataflow graph which may be used to select the target node. Thus, the target node may be selected based on the aggressiveness indication. The aggressiveness indication may be obtained using any suitable technique, including, but not limited to, receiving the aggressiveness indication from a user, using a setting within graphAMP, reading a settings file, or extracting it from the representation of the dataflow graph. The aggressiveness indication may identify a node function for changing precision, so the target node may be selected based on the node function identified by the aggressiveness indication.

The aggressiveness indication can guide graphAMP in categorizing operations into three disjoint sets: the deny set, the allow set, and the infer set. A target node may be selected based on it being in the allow set. Implementations of graphAMP may include multiple pre-defined aggressiveness indications, such as a conservative indication, a strict indication, a moderate indication, and a liberal indication.

For instance, a conservative aggressiveness indication may result in all operations being assigned to the deny set, ensuring that no changes to precision are made. This maintains the data precision of the original the graph. A liberal aggressiveness indication may place all operations in the allow set, even input and output tensors in some cases, permitting significant precision reductions to enhance performance and energy efficiency, albeit with the risk of reduced accuracy. Intermediate levels of aggressiveness can balance between these levels, allowing selective precision adjustments based on the numerical stability of operations and their context within the graph.

The aggressiveness indication also affects the propagation of precision requirements through the graph. In cases where the indication is more aggressive, the algorithm may propagate lower precision requirements upstream more extensively, converting more nodes to lower precision. This approach ensures that numerically stable operations benefit from reduced precision, while numerically sensitive operations retain higher precision to maintain overall model accuracy. By dynamically adjusting the precision based on the aggressiveness indication, graphAMP optimizes the computational graph for both performance and accuracy, tailored to the specific needs and constraints of the application.

The mapping of various nodes to the three design sets based on the aggressiveness indication can be done using any suitable technique, but graphAMP may retrieve a list of functions for the three sets based on the aggressiveness indicator. In at least one implementation, graphAMP obtains, based on the aggressiveness indication, a first list of node functions and a second list of node functions. It then assigns nodes of the graph that have a function included in the first list of node functions to the allow set and assigns nodes of the graph that have a function included in the second list of node functions to the infer set. It then assigns nodes of the graph that have a function not included in either the first list of node functions or the second list of node functions to the deny set.

In one specific example, if the aggressiveness indication has a conservative semantic meaning, graphAMP retrieves list C1 as the first list of node functions and list C2 as the second list of node functions in response to. Both list C1 and C2 are empty, meaning that all nodes in the graph will be assigned to the deny set and no changes will be made to the graph by graphAMP. If the aggressiveness indication has a strict semantic meaning, graphAMP retrieves list S1 as the first list of node functions and list S2 as the second list of node functions. List S1 includes a node function implementing a matrix multiply operation and list S2 is empty. Thus, any node in the graph that implements the matrix multiply operation is assigned to the allow set and the other nodes of the graph are assigned to the deny set.

Continuing with the same example, if the aggressiveness indication has a moderate semantic meaning, graphAMP retrieves list M1 as the first list of node functions and list M2 as the second list of node functions. List M1 includes a node function implementing a matrix multiply operation, list M2 includes a node function implementing a data reorganization operation, such as a transpose or reshape, and at least one node of the one or more nodes has a node function that is not in list M1 or list M2. List M1 may include other operations, such as a linear affine transformation, a gradient calculation, and/or any operation using a multiply. Thus, any node in the graph that implements an operation in list M1 is assigned to the allow list, any node in the graph that implements an operation in list S2 is assigned to the infer set, and any other nodes in the graph are assigned to the deny set. And if the aggressiveness indication has a liberal semantic meaning, graphAMP retrieves list L1 as the first list of node functions and list L2 as the second list of node functions in response to the aggressiveness indication having a third semantic meaning. List L1 includes all node functions of the one or more nodes and list L2 is empty, so all nodes of the graph are assigned to the allow set.

Thus, computational graph 400 in FIG. 4 represents an output graph generated by graphAMP using graph 300 as its input with the matrix multiply operation (MatMul 325 and MatMul 350) in the allow set and other nodes in graph 300 (Input 310, Transpose 312, Weight 320, Scale 330, Softmax 335, Permute 340, ReLU 355, and Output 360) in the deny set. This may be a result of a strict aggressiveness indication which only includes matrix multiply operations in the allow set and puts all other operations in the deny set.

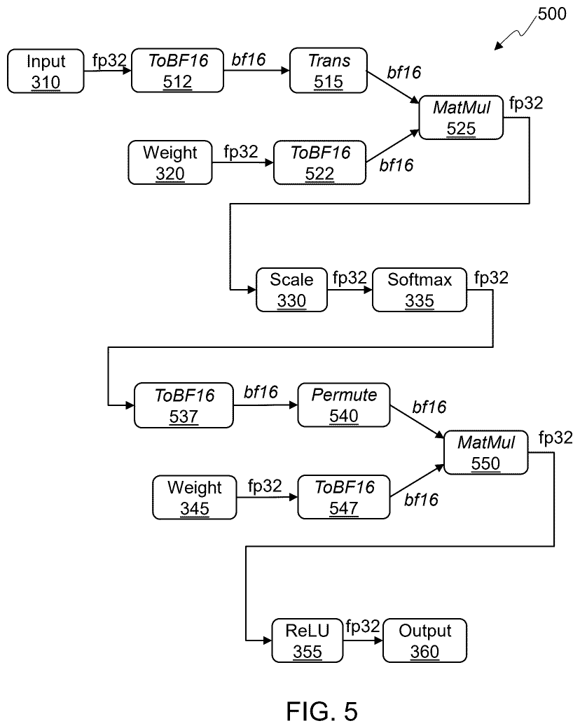

FIG. 5 shows an example of computational graph 500 with mixed-precision datatypes, illustrating the conversion of datatypes for various operations of the dataflow graph 300 of FIG. 3, based on a predefined aggressiveness indication. Once the aggressiveness indication has been obtained, each node of the input graph 300 is assigned to one of the allow set, the infer set, or the deny set. In this example, the aggressiveness indication is a moderate aggressiveness indication that puts matrix multiply operations in the allow set and puts permute and transpose operations in the infer set. Other operations of the graph 300 are put in the deny set for this example.

A backward traversal of graph 300 is performed, starting at the Output 360 and going to the ReLU node 355, both of which use fp32. Because both of those functions are in the deny set, those nodes are copied to the output graph 500 unchanged. The next node encountered in the backwards traversal, MatMul 350, is in the allow set, so it is selected as a target node and changed to use lower data precision (bf16) for its inputs, changing the data precision of its inputs to the changed data precision bf16. A downcast MatMul node 550 is then added to the output graph 500.

An input of MatMul 350 has a first preceding node of Weight 345. It is identified as a preceding node by having its output connected to an input of the target node by an edge of the graph. Once it is determined that the first preceding node, Weight 345, is in the deny set, it is copied to the output graph 500 and a conversion node, ToBF16 547, is inserted between it and the target node in the output graph 500 to change a precision of data provided by the output of the preceding node to the changed data precision before passing it to the input of the target node.

Another input of MatMul 350 has a preceding node of Permute 340. It is identified as a second preceding node by having its output connected to an input of the target node by an edge of the graph. Once it is determined that the preceding node, Permute 340, is in the allow set or the infer set, in this case, the infer set, graphAMP may change, based on the changed data precision of the input of the target node, an output data precision of the preceding node. In addition, graphAMP may change at least one of a data precision for an input of the preceding node, or a data precision of an internal calculation of the preceding node. Thus, a downcast Permute 540, using bf16 for both its input and its output, is added to the output graph 500.

The backward traversal of the input graph 300 continues and finds that Softmax 335 is in the deny set, so a conversion node, ToBF16 537, is added to the output graph 500 along with Softmax 335. Scale 330 is also copied to the output graph 500 due to its inclusion in the deny set.

MatMul 335, is in the allow set, so MatMul 525 with bf16 inputs is added to the output graph 500. A conversion node, ToBF16 522, is added to the output graph 500 along with Weight 320. Transpose 315 is in the infer set, to it is downcast to Transpose 515 using bf16 in the output graph, along with conversion node ToBF16 512 and Input 310.

It can be seen from comparing the output graph 400 generated with a strict aggressiveness indication to the output graph 500 generated with a moderate aggressiveness indication that more computation is performed in bf16, as compared to fp32, with the moderate aggressiveness indication, resulting in faster execution and lower power consumption, with both performing fewer operations in fp32 than the input graph 300. And for the example shown, very little, if any, accuracy is compromised in the change from the original graph 300, to either the output graph 400 generated with the strict aggressiveness indication or the output graph 500 generated with a moderate aggressiveness indication.

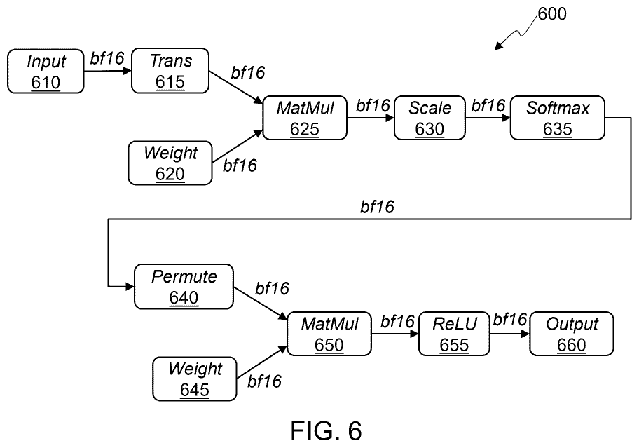

FIG. 6 shows an example of computational graph 600 with mixed-precision datatypes, illustrating the conversion of datatypes for various operations of the dataflow graph 300 of FIG. 3, based on a different predefined aggressiveness indication. In this example, the aggressiveness indication is a liberal aggressiveness indication that puts all operations in the allow set, leaving both the infer set and the deny set empty.

In this example, graphAMP starts the traversal at the Output 360 and finds that it is in the allow set, so it changes it to use bf16 for both its output and input and places Output 660 in the output graph 600. It then identifies ReLU 355 as a preceding node and determines that it is eligible for data precision adjustment because it is also in the allow set for this example. GraphAMP changes it to use bf16 and puts ReLU 655 into the output graph 600. It continues to traverse the graph and determines that MatMul 350, Permute 340, Softmax 335, Scale 330, MatMul 325, and Transpose 315 are all eligible for data precision adjustment because they are all in the allow set. It respectively replaces those nodes in the output graph 600 with MatMul 650, Permute 640, Softmax 635, Scale 630, MatMul 625, and Transpose 615 which use a lower data precision for their input and output as well as, in at least some cases, for an internal calculation.

Tensors that are provided to the graph 300, Input 310, Weight 320, and Weight 345, which are also in the allow set for this example, may be converted to bf16 offline before being provided to the graph 600 as Input 610, Weight 620, and Weight 645. In other implementations, or with yet another aggressiveness indication, the input nodes may be put into the deny set and conversion nodes inserted into the graph to avoid changing the actual tensor data.

The output graph 600 performs all (or nearly all) of its calculations at the lower changed precision, bf16 in this example, saving even more power and providing even higher performance than output graphs 300, 400, 500 generated with less liberal aggressiveness indications, but depending on the input tensors 310, 320, 345 may have lower accuracy. But the wide range of options provides a user with the ability to tailor their graph to an optimum tradeoff between efficiency, speed, and accuracy.

GraphAMP, in each of the examples above to generate an output graph equivalent to the input graph 300 using a conservative aggressiveness indicator, an output graph 400 with a strict aggressiveness indicator, output graph 500 with a moderate aggressiveness indicator, and an output graph 600 with a liberal aggressiveness indicator, may generate computer instructions for one or more processors to execute the dataflow graph including the changed data precision and store the computer instructions on a non-transitory computer-readable storage medium.

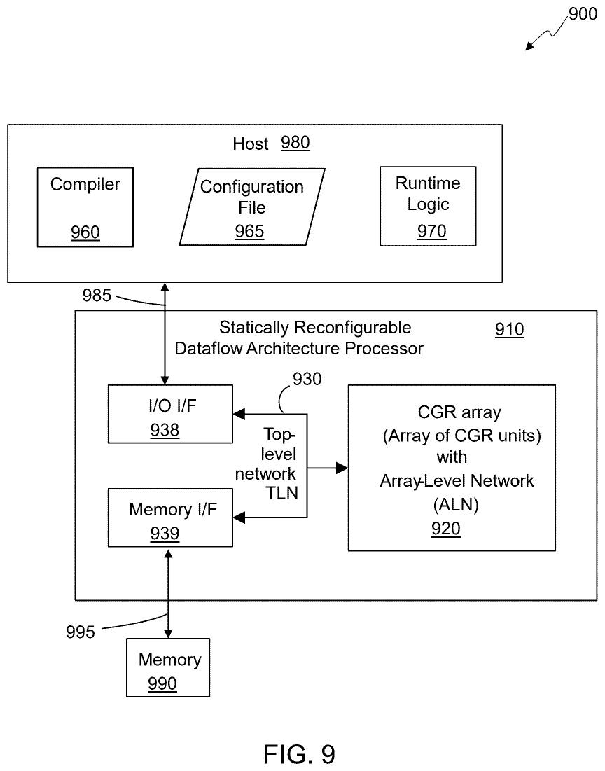

In at least one implementation, graphAMP may obtain a representation of a dataflow graph and generate first computer instructions for the one or more processors to execute the dataflow graph as defined by the representation of the dataflow graph. A first set of tensors may be obtained and the one or more processors, which may be a CGR processor as described in FIG. 9-19, may execute the first computer instructions to process the first set of tensors. In some cases, the first computer instructions may be generated to implement a first changed output graph created using a first aggressiveness indicator, such as, but not limited to, a conservative aggressiveness indicator with many functions mapped to the deny set or a strict aggressiveness indicator with a small set of functions in the approve set.

Runtime statistics may be generated for at least a subset of the one or more nodes during the executing of the first computer instructions and a target node may be selected for changed data precision based on the runtime statistics. In some implementations, a new aggressiveness indication may be automatically selected based on the runtime statistics. The new aggressiveness indication may include more of fewer operations in the allow set and/or infer set than the initial aggressiveness indication, depending on the statistics. The nodes of the graph may be reassigned to one of the allow set, the infer set, or the deny set, based on the new aggressiveness indication. An updated dataflow graph with changed data precision for at least on input, output, or internal calculation for at least one node may be generated by graphAMP based on the target node, the new aggressiveness indication, and/or the reassignment of then nodes to one of the three sets, and second computer instructions generated based on the updated dataflow graph. A second set of tensors may then be obtained, and the second computer instructions executed by the one or more processors to process the second set of tensors using the changed data precision. The first set of tensors and/or the second set of tensors may be training data used to train the dataflow graph.

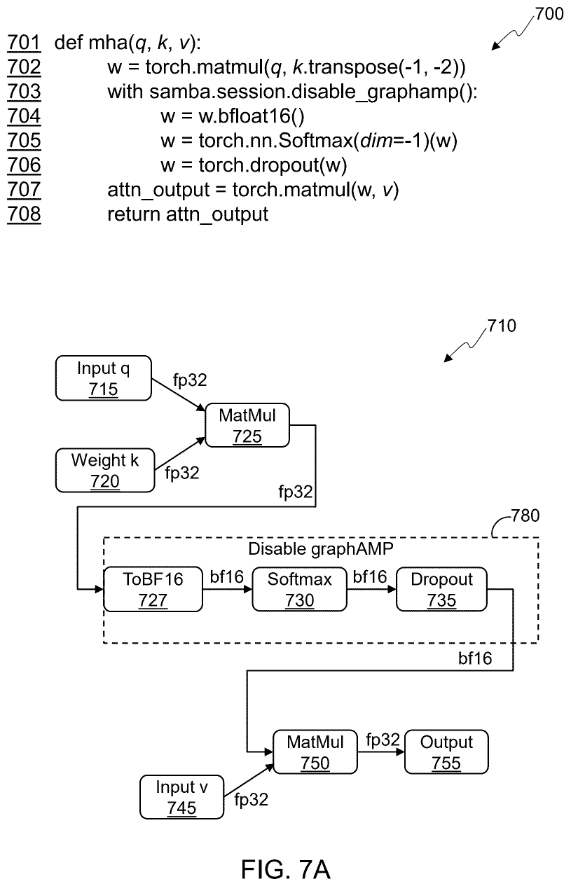

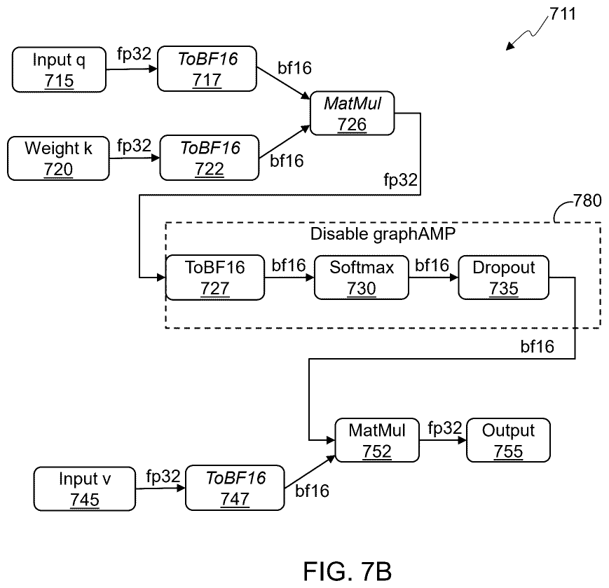

FIG. 7A provides two representations 700, 710 of the same example computational graph with graphAMP disabled for a subgraph 780. The first representation 700 of the computational graph uses text to describe the graph, such as may be done in various high-level programming languages. The first line 701 defines a multi-head attention (MHA) function with three inputs, q, k, and v. The second line 702 performs a matrix multiply of inputs q and k. The third line 703 disables graphAMP for the subgraph defined by lines 704, 705, 706 which convert the output of the matrix multiply from fb32 to bf16 (line 704), perform a Softmax function (line 705), and perform a dropout function (line 706). Line 707 performs another matrix multiply of the output of the dropout function and the v input which is then returned as the output in line 708. Any type of programming language or textual representation may be used in various implementations.

The second representation 710 shows the same MHA function in graphical form. Input q 715 and Weight k are received in fp32 format and provided to MatMul 725. The output of MatMul 725 is provided to a subgraph 780 which is shown as being disabled for graphAMP. Subgraph 780 includes an explicit ToBF16 node 727 to convert the fp32 output of MatMul 725 to bf16, Softmax 730, and Dropout 735. The output of the subgraph 780 (which is the output of Dropout 735) is provided to MatMul 750 which performs a matrix multiply of that output with Input v 745 and provides a fp32 Output 755.

FIG. 7B illustrates a computational graph with mixed precision showing an example output 711 of graphAMP for the computational graph of FIG. 7A. GraphAMP may receive a representation of a graph, such as the first representation 701 or the second representation 710 of the MHA function. GraphAMP may also obtain an instance override for an exclusion set of nodes. The exclusion set of nodes is a subset of the one or more nodes of the computational graph that are to be excluded from evaluation by graphAMP. The instance override can be obtained using any suitable technique, such as having the instance override included in the representation of the dataflow graph, such as shown in the first representation 701 and the second representation 710, or obtaining the instance override from a user, interactively or as a separate input, or obtaining it from a separate computer file or library.

GraphAMP may then process the computational graph from FIG. 7A. While textual representation 701 may be used, this description will refer to the graphical representation 710. An aggressiveness indication may be obtained and each node of the input graph 710 assigned to one of an allow set, an infer set, and a deny set. For the purposes of this example, the MatMul 725 and MatMul 750 are assigned to the allow set and Dropout 725 is assigned to the infer set. Input 715, Weight k 720, ToBF17 727, Softmax 730, Input v 745, and Output 755 are assigned to the deny set. Note that some implementations may assign nodes identified as being in the exclusion set of nodes directly to the deny set, independent of the aggressiveness indication.

GraphAMP selects MatMul 750 as a target node from the allow set and adjusts the datatype for its inputs to bf16, putting MatMul 752 into the output graph 711, along with Output 755 (which is in the deny set). Because Input v 745 is in the deny set, graphAMP inserts a conversion node, ToBF16 747 between Input v 745 and the input to MatMul 752 and adds ToBF16 747 and Input v 745 into the output graph 711. GraphAMP may identify Dropout 735 as a preceding node to MatMul 752, but because it is in the exclusion set of nodes 780, it is not evaluated to determine if data precision for its input, output or internal calculations can be adjusted, even though it is in the infer set. This excludes nodes in the exclusion set of nodes from being selected as the target node. So, the nodes in the exclusion set of nodes, ToBF17 727, Softmax 730, and Dropout 735, are added into the output graph 711 unchanged.

GraphAMP continues and selects MatMul 725 as a target node from the allow set and adjusts the datatype for its inputs to bf16, putting MatMul 726 into the output graph 711, along with Input 715 and Weight k 720, (which are in the deny set). Because Input 715 and Weight k 720 are in the deny set, graphAMP inserts conversion nodes, ToBF16 717, 722 into the output graph 711. Thus, graphAMP completes the conversion of input graph 710 with identification of an exclusion set of nodes 780 into output graph 711 with mixed-precision calculations.

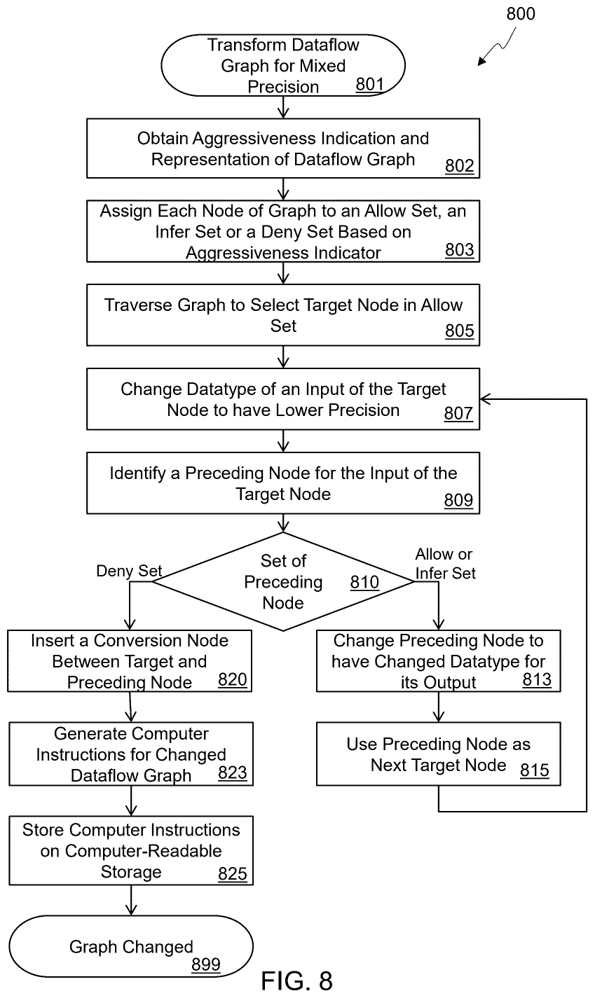

FIG. 8 illustrates a flowchart 800 of an example implementation of a computer-implemented method 801 of transforming a dataflow graph to execute on one or more processors using mixed precision. Implementations of graphAMP may include the method of flowchart 800 which may be used by a compiler for computational graphs. The method begins with obtaining 802 an aggressiveness indication and a representation of the dataflow graph, which includes one or more nodes connected by one or more edges having a respective datatype with a respective precision representing dataflow in the dataflow graph. This provides information about the graph structure and the desired level of precision adjustment.

In some cases, the method of flowchart 800 may break a dataflow graph into subgraphs for processing by graphAMP, with each subgraph being processed separately by the method of flowchart 800 or by another method described herein. In some cases, the graph may be a cyclic directed graph (i.e., a graph with an edge that goes from a node to an ancestor node of that node to create a feedback loop). A cyclic directed graph may be broken into one or more acyclic subgraphs (i.e., a graph without a feedback loop), with the acyclic subgraphs processed separately as a dataflow graph by graphAMP.

Next, the method involves assigning 803 each node of the one or more nodes to one of an allow set, an infer set, or a deny set based on the aggressiveness indication. This categorization determines how each node's precision will be managed during the transformation process. Nodes in the allow set can have their precision reduced, nodes in the infer set will match the precision of their downstream consumers, and nodes in the deny set will retain their original precision.

The method then traverses 805 the dataflow graph from an output of the dataflow graph to find a node of the one or more nodes in the allow set to select as the target node. This traversal ensures that the precision adjustments are made in a context-aware manner, starting from the graph's output, and moving upstream. The traversal can be any type of traversal from the output upstream through the dataflow graph.

The target node has an input with a first datatype at a first data precision, an output with a second datatype at a second data precision and may include an internal computation using a third datatype at a third data precision. Depending on an implementation of the target node, the first, second, and third datatype may be equal to each other (i.e., the same datatype), may be of equivalent types (e.g., all floating-point, all fixed point, or all integer) with different data precisions, or may be of dissimilar types. Any combination of datatypes may be used for the first, second, and third datatypes.

Once the target node is identified, the method automatically changes 807 the input of the target node to utilize a changed datatype having a changed precision that is less than the first data precision. This reduces the precision of the target node's input, which can lead to performance improvements and reduced computational load.

The method then identifies 809 a preceding node of the one or more nodes having its output connected to the input of the target node by an edge of the one or more edges. This may be a part of the tree traversal process. A determination 810 is then made as to which set the preceding node is assigned. Note that if the target node has multiple inputs, a preceding node for each input may be identified and processed as described herein.

In response to determining that the preceding node is in the allow set or the infer set, the method automatically changes 813 the preceding node to have the changed datatype for the output and recursively repeats 815 the steps of changing 807 the input precision, identifying 809 preceding nodes, and determining 810 their sets. This recursive process continues until relevant nodes have been processed and their precisions adjusted accordingly.

In response to determining that the preceding node is in the deny set, the method automatically inserts 820 a conversion node between the preceding node and the target node to change data of the first datatype provided by the output of the preceding node into the changed datatype having the changed data precision before passing the changed datatype to the input of the target node. This conversion ensures that the data passed to the target node is the correct datatype for the target node.

The method may continue to traverse the tree in an upstream direction, looking for additional nodes in the allow set. In some implementations, each node in the dataflow graph is evaluated and changed to a lower precision if appropriate. In other implementations, the method may be used on a subgraph, such as for a graph of an operation.

The method can generate 823 computer instructions for the one or more processors to execute the dataflow graph including the changed data precision and stores 825 the computer instructions on a non-transitory computer-readable storage medium. Thus, the method changes 899 the graph. This allows the transformed dataflow graph can be executed efficiently on the target hardware, leveraging the benefits of mixed precision.

By obtaining an aggressiveness indication and a representation of the dataflow graph, the method allows for a flexible and context-aware approach to precision adjustment. This ensures that the precision of data types can be optimized based on the specific requirements and characteristics of the computational graph, leading to improved performance and energy efficiency.

Reviewing FIG. 8, assigning each node to one of an allow set, an infer set, or a deny set based on the aggressiveness indication enables a dataflow graph compiler to automatically and selectively lower data precision used in the graph to improve performance and energy efficiency, while still managing the numerical sensitivity of different operations. This categorization allows numerically sensitive operations to maintain higher precision, even as the aggressiveness indicator increases, while still allowing numerically stable operations to be downcast to lower precision, thereby optimizing the overall computational efficiency without compromising accuracy.

Traversing the dataflow graph from the output to find a node in the allow set allows precision adjustments to be made in a context-aware manner. This reverse traversal allows the method to consider the dependencies and connections between nodes, minimizing any negative impact of precision changes on downstream operations.

Automatically changing the input of the target node to a lower precision datatype reduces the computational load and energy consumption for that node. This change is made based on the context provided by the aggressiveness indication. Thus, the precision adjustment is appropriate for the specific operation and its role within the graph.

Identifying preceding nodes and determining their set assignments allows the method to propagate precision adjustments upstream. This allows the entire computational graph to be optimized for mixed precision, with each node's precision being adjusted based on its context and dependencies.

Inserting conversion nodes at the output of nodes in the deny set nodes ensures that data is passed downstream using the correct datatype, maintaining the integrity and accuracy of the computational graph, while keeping the nodes in the deny set at their designated data precision. This allows for seamless integration of mixed-precision operations without requiring manual intervention or extensive modifications to the original graph and maintains the data precision for numerically sensitive operations.

Generating and storing computer instructions for the transformed dataflow graph allows the optimized graph can be executed on the target hardware. This step translates the precision adjustments into executable code, enabling the practical application of the mixed-precision optimization.

Overall, the method provides a systematic and automated approach to optimizing the precision of data types in a computational graph. By considering the context and dependencies of each node, the method enhances performance and energy efficiency while maintaining the accuracy and integrity of the computational graph.

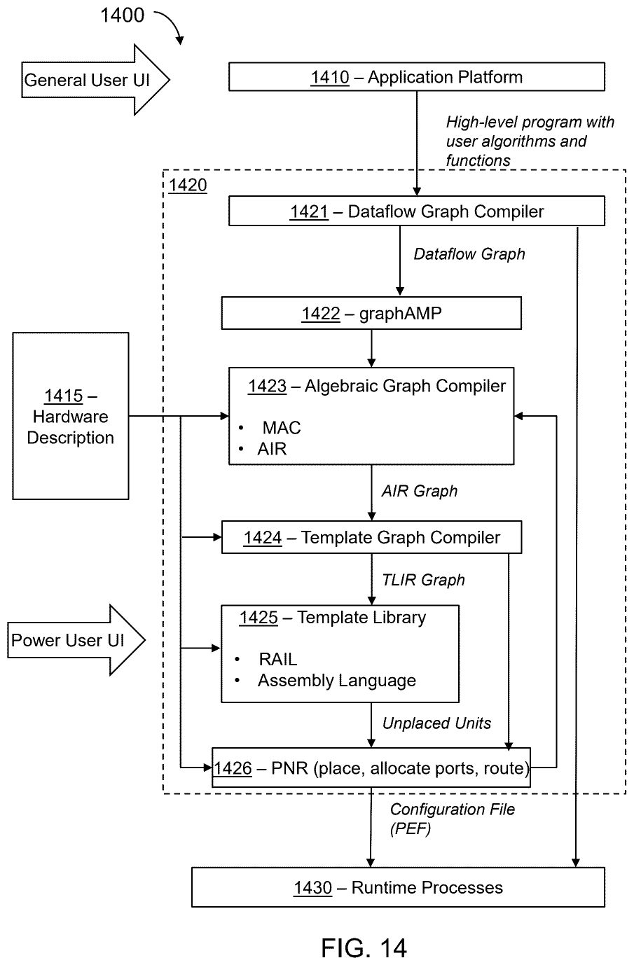

Translation of high-level programs to executable bit files is performed by a compiler, see, for example, FIGS. 14-19. The compiler may use one or more of the methods for transforming a dataflow graph to use mixed precision that are described above. In some implementations, the computer hardware used to execute the computer instructions (which may take the form of configuration files in some implementations) generated by the compiler may be a coarse-grained reconfigurable (CGR) processor, which may be well-suited for executing a dataflow graph. While traditional compilers sequentially map operations to processor instructions, typically without regard to pipeline utilization and duration (a task usually handled by the hardware), an array of CGR units in the CGR processor requires mapping operations to processor instructions in both space (for parallelism) and time (for synchronization of interdependent computation graphs or dataflow graphs). This requirement implies that a compiler for a CGRA must decide which operation of a computation graph or dataflow graph is assigned to which of the CGR units, and how both data and, related to the support of dataflow graphs, control information flows among CGR units, and to and from external hosts and storage. This process, known as “place and route”, is one of many new challenges posed to compilers for arrays of CGR units.

FIG. 9 illustrates an example system 900 including a CGR processor 910, a host 980, and a memory 990. CGR processor 910 has a coarse-grained reconfigurable architecture (CGRA) and includes an array of CGR units 920 such as a CGR array. The system 900, or at least the CGR processor 910 of the system 900, may be suitable to execute the computer instructions created by one or more methods described herein.

CGR processor 910 further includes an IO interface 938, and a memory interface 939. The array of CGR units 920 is coupled with IO interface 938 and memory interface 939 via data bus 930 which may be part of a top-level network (TLN). Host 980 communicates with IO interface 938 via system data bus 985, and memory interface 939 communicates with memory 990 via memory bus 995. Array of CGR units 920 may further include compute units and memory units that are connected with an array-level network (ALN) to provide the circuitry for execution of a computation graph or a dataflow graph that may have been derived from a high-level program with user algorithms and functions. The high-level program may include a set of procedures, such as learning or inferencing in an AI or ML system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. In some implementations, execution of the graph(s) may involve using multiple units of CGR processor 910. In some implementations, CGR processor 910 may include one or more ICs. In other implementations, a single IC may span multiple CGR processors. In further implementations, CGR processor 910 may include one or more units of array of CGR units 920.

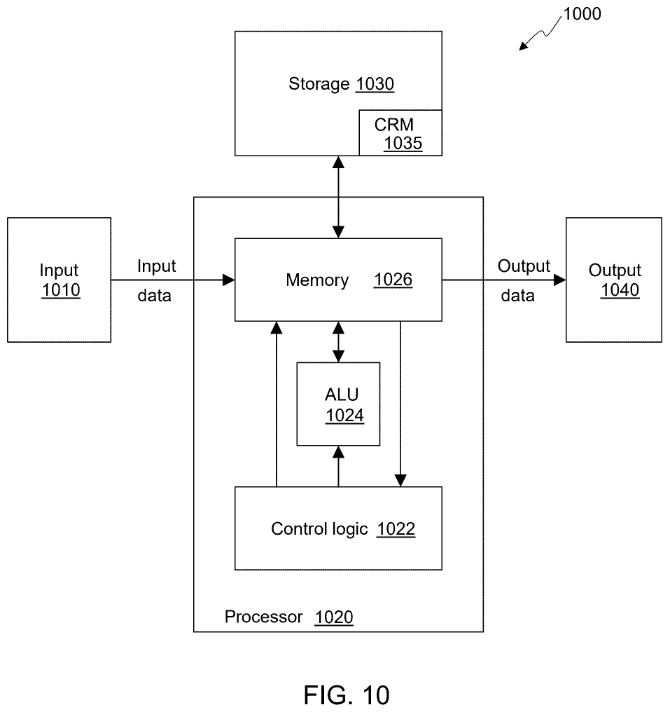

Host 980 may be, or may include, a computer such as further described with reference to FIG. 10. Host 980 runs runtime processes, as further referenced herein, and may also be used to run computer programs, such as the compiler 960 further described herein with reference to FIG. 14. In some implementations, the compiler may run on a computer that is similar to the computer described with reference to FIG. 10, but separate from host 980.

CGR processor 910 may accomplish computational tasks by executing a configuration file 965 (for example, a PEF file). For the purposes of this description, a configuration file corresponds to a dataflow graph, or a translation of a dataflow graph, and may further include initialization data. A compiler 960 compiles the high-level program to provide the configuration file 965. Runtime processes 970 may install the configuration file 965 in CGR processor 910. In some implementations described herein, a CGR array is configured by programming one or more configuration stores with all or parts of the configuration file 965. A single configuration store may be at the level of the CGR processor 910 or the CGR array 920, or a CGR unit may include an individual configuration store. The configuration file 965 may include configuration data for the CGR array 920 and CGR units in the CGR array 920 and link the computation graph to the CGR array 920. Execution of the configuration file by CGR processor 910 causes the CGR array 920 to implement the user algorithms and functions in the dataflow graph.

CGR processor 910 can be implemented on a single integrated circuit die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

FIG. 10 illustrates an example of a computer 1000, including an input device 1010, a processor 1020, a storage device 1030, and an output device 1040. The computer 1000 may be useable as the host 980 of FIG. 1 and may be suitable to run the compiler 960 which may implement one or more of the methods described here. Although the example computer 1000 is drawn with a single processor, other implementations may have multiple processors. Input device 1010 may comprise a mouse, a keyboard, a sensor, an input port (for example, a universal serial bus (USB) port), and any other input device known in the art. Output device 1040 may comprise a monitor, printer, and any other output device known in the art. Furthermore, part or all of input device 1010 and output device 1040 may be combined in a network interface, such as a Peripheral Component Interconnect Express (PCIe) interface suitable for communicating with CGR processor 910. Input device 1010 is coupled with processor 1020 to provide input data, which an implementation may store in memory 1026. Processor 1020 is coupled with output device 1040 to provide output data from memory 1026 to output device 1040. Processor 1020 further includes control logic 1022, operable to control memory 1026 and arithmetic and logic unit (ALU) 1024, and to receive program and configuration data from memory 1026. Control logic 1022 further controls exchange of data between memory 1026 and storage device 1030. Memory 1026 typically comprises memory with fast access, such as static random-access memory (SRAM), whereas storage device 1030 typically comprises memory with slow access, such as dynamic random-access memory (DRAM), flash memory, magnetic disks, optical disks, and any other memory type known in the art. At least a part of the memory in storage device 1030 includes a non-transitory computer-readable medium (CRM 1035), such as used for storing computer programs. The computer instructions, which may include a configuration file 965 for the CGR processor 910, generated by the compiler 960 may be stored in the CRM 1035.

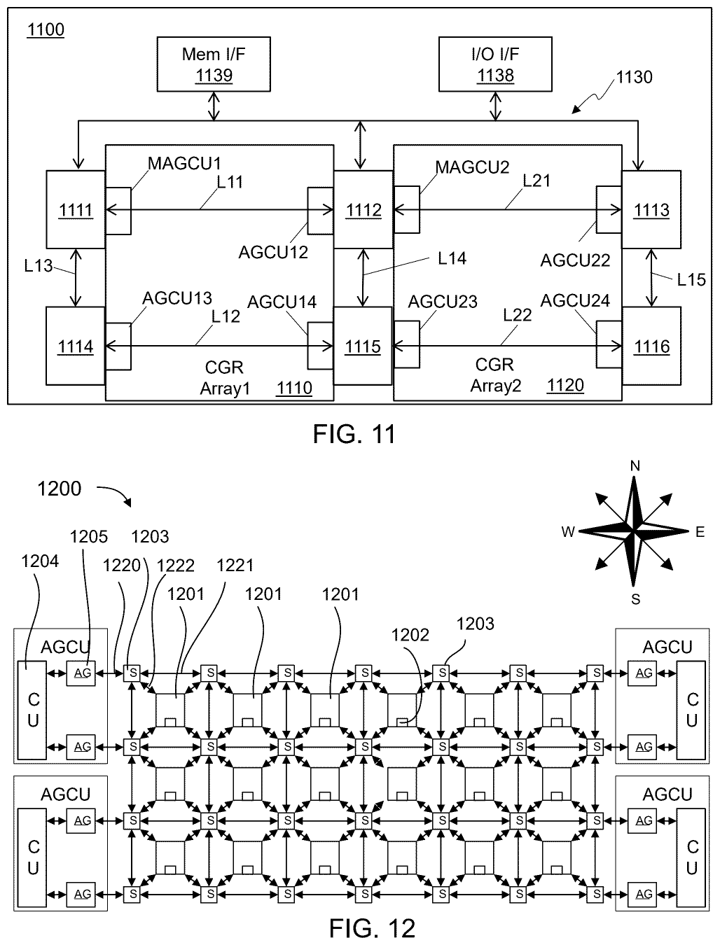

FIG. 11 illustrates example details of a CGR architecture 1100 including a top-level network (TLN 1130) and two CGR arrays (CGR array 1110 and CGR array 1120). A CGR array comprises an array of CGR units (e.g., PMUs, PCUs, FCMUs) coupled via an array-level network (ALN), e.g., a bus system. The ALN is coupled with the TLN 1130 through several AGCUs, and consequently with I/O interface 1138 (or any number of interfaces) and memory interface 1139. Other implementations may use different bus or communication architectures.

Circuits on the TLN in this example include one or more external I/O interfaces, including I/O interface 1138 and memory interface 1139. The interfaces to external devices include circuits for routing data among circuits coupled with the TLN and external devices, such as high-capacity memory, host processors, other CGR processors, FPGA devices, and the like, that are coupled with the interfaces.

Each depicted CGR array has four AGCUs (e.g., MAGCU1, AGCU12, AGCU13, and AGCU14 in CGR array 1110). The AGCUs interface the TLN to the ALNs and route data from the TLN to the ALN or vice versa. Other implementations may have different numbers of AGCUS.

One of the AGCUs in each CGR array in this example is configured to be a master AGCU (MAGCU), which includes an array configuration load/unload controller for the CGR array. The MAGCU1 includes a configuration load/unload controller for CGR array 1110, and MAGCU2 includes a configuration load/unload controller for CGR array 1120. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

The TLN is constructed using top-level switches (switch 1111, switch 1112, switch 1113, switch 1114, switch 1115, and switch 1116) coupled with each other as well as with other circuits on the TLN, including the AGCUs, and external I/O interface 1138. The TLN includes links (e.g., L11, L12, L21, L22) coupling the top-level switches. Data may travel in packets between the top-level switches on the links, and from the switches to the circuits on the network coupled with the switches. For example, switch 1111 and switch 1112 are coupled by link L11, switch 1114 and switch 1115 are coupled by link L12, switch 1111 and switch 1114 are coupled by link L13, and switch 1112 and switch 1113 are coupled by link L21. The links can include one or more buses and supporting control lines, including for example a chunk-wide bus (vector bus). For example, the top-level network can include data, request, and response channels operable in coordination for transfer of data in any manner known in the art.

FIG. 12 illustrates an example CGR array 1200, including an array of CGR units in an ALN. CGR array 1200 may include several types of CGR unit 1201, such as FCMUs, PMUs, PCUs, memory units, compute units, AGCUs, and/or switches. For examples of the functions of these types of CGR units, see Prabhakar et al., “Plasticine: A Reconfigurable Architecture for Parallel Patterns”, ISCA 2017 Jun. 24-28, 2017, Toronto, ON, Canada. Each of the CGR units may include a configuration store 1202 comprising a set of registers or flip-flops storing configuration data that represents the setup and/or the sequence to run a program, and that can include the number of nested loops, the limits of each loop iterator, the instructions to be executed for each stage, the source of operands, and the network parameters for the input and output interfaces. In some implementations, each CGR unit 1201 comprises an FCMU. In other implementations, the array comprises both PMUs and PCUs, or memory units and compute units, arranged in a checkerboard pattern. In yet other implementations, CGR units may be arranged in different patterns. The ALN includes switch units 1203 (S), and AGCUs (each including two address generators 1205 (AG) and a shared coalescing unit 1204 (CU)). Switch units 1203 are connected among themselves via interconnects 1221 and to a CGR unit 1201 with interconnects 1222. Switch units 1203 may be coupled with address generators 1205 via interconnects 1220. In some implementations, communication channels can be configured as end-to-end connections, and switch units 1203 are CGR units. In other implementations, switches route data via the available links based on address information in packet headers, and communication channels establish as and when needed.

A configuration file may include configuration data representing an initial configuration, or starting state, of each of the CGR units that execute a high-level program with user algorithms and functions. Program load is the process of setting up the configuration stores in the CGR array based on the configuration data to allow the CGR units to execute the high-level program. Program load may also require loading memory units and/or PMUs.

The ALN includes one or more kinds of physical data buses, for example a chunk-level vector bus (e.g., 512 bits of data), a word-level scalar bus (e.g., 32 bits of data), and a control bus. For instance, interconnects 1221 between two switches may include a vector bus interconnect with a bus width of 512 bits, and a scalar bus interconnect with a bus width of 32 bits. A control bus can comprise a configurable interconnect that carries multiple control bits on signal routes designated by configuration bits in the CGR array's configuration file. The control bus can comprise physical lines separate from the data buses in some implementations. In other implementations, the control bus can be implemented using the same physical lines with a separate protocol or in a time-sharing procedure.

Physical data buses may differ in the granularity of data being transferred. In one implementation, a vector bus can carry a chunk that includes 16 channels of 32-bit floating-point data or 32 channels of 16-bit floating-point data (i.e., 512 bits) of data as its payload. A scalar bus can have a 32-bit payload and carry scalar operands or control information. The control bus can carry control handshakes such as tokens and other signals. The vector and scalar buses can be packet-switched, including headers that indicate a destination of each packet and other information such as sequence numbers that can be used to reassemble a file when the packets are received out of order. Each packet header can contain a destination identifier that identifies the geographical coordinates of the destination switch unit (e.g., the row and column in the array), and an interface identifier that identifies the interface on the destination switch (e.g., North, South, East, West, etc.) used to reach the destination unit.

A CGR unit 1201 may have four ports (as drawn) to interface with switch units 1203, or any other number of ports suitable for an ALN. Each port may be suitable for receiving and transmitting data, or a port may be suitable for only receiving or only transmitting data.

A switch unit, as shown in the example of FIG. 12, may have eight interfaces. The North, South, East and West interfaces of a switch unit may be used for links between switch units using interconnects 1221. The Northeast, Southeast, Northwest, and Southwest interfaces of a switch unit may each be used to make a link with an FCMU, PCU or PMU instance using one of the interconnects 1222. Two switch units in each CGR array quadrant have links to an AGCU using interconnects 1220. The AGCU coalescing unit arbitrates between the AGs and processes memory requests. Each of the eight interfaces of a switch unit can include a vector interface, a scalar interface, and a control interface to communicate with the vector network, the scalar network, and the control network. In other implementations, a switch unit may have any number of interfaces.

During execution of a graph or subgraph in a CGR array after configuration, data can be sent via one or more switch units and one or more links between the switch units to the CGR units using the vector bus and vector interface(s) of the one or more switch units on the ALN. A CGR array may comprise at least a part of CGR array 1200, and any number of other CGR arrays coupled with CGR array 1200.

A data processing operation implemented by CGR array configuration may comprise multiple graphs or subgraphs specifying data processing operations that are distributed among and executed by corresponding CGR units (e.g., FCMUs, PMUs, PCUs, AGs, and CUs).

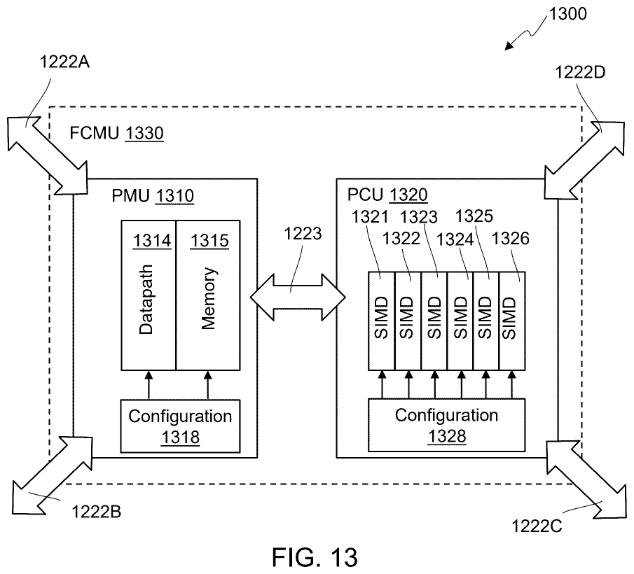

FIG. 13 illustrates an example 1300 of a PMU 1310 and a PCU 1320, which may be combined in an FCMU 1330. PMU 1310 may be directly coupled to PCU 1320, or optionally via one or more ALN links 1223, or optionally via links through one or more switches. The FCMU 1330 may include multiple ALN links, such as northwest ALN link 1222A and southwest ALN link 1222B, which may connect to PMU 1310, and southeast ALN link 1222C and northeast ALN link 1222D, which may connect to PCU 1320. The northwest ALN link 1222A, southwest ALN link 1222B, southeast ALN link 1222C, and northeast ALN link 1222D connect to switches 1203 as shown in FIG. 12. Each ALN link 1222A-D, 1223 may include one or more scalar links, one or more vector links, and one or more control links where an individual link may be unidirectional into FCMU 1330, unidirectional out of FCMU 1330 or bidirectional. FCMU 1330 can include FIFOs to buffer data entering and/or leaving the FCMU 1330 on the links.

PMU 1310 may include an address converter 1314, a scratchpad memory 1315, and a configuration store 1318. Configuration store 1318 may be loaded, for example, from a program running on host 980 as shown in FIG. 9 and can configure address converter 1314 to generate or convert address information for scratchpad memory 1315 based on data received through one or more of the ALN links 1222A-B, and/or 1223. Data received through ALN links 1222A-B, and/or 1223 may be written into scratchpad memory 1315 at addresses provided by address converter 1314. Data read from scratchpad memory 1315 at addresses provided by address converter 1314 may be sent out on one or more of the ALN links 1222A-B, and/or 1223.

PCU 1320 includes two or more processor stages, such as SIMD 1321 through SIMD 1326, and configuration store 1328. The processor stages may include ALUs, or SIMDs, as drawn, or any other reconfigurable stages that can process data. PCU 1320 may receive data through ALN links 1222C-D, and/or 1223, and process the data in the two or more processor stages or store the data in configuration store 1328. PCU 1320 may produce data in the two or more processor stages and transmit the produced data through one or more of the ALN links 1222C-D, and/or 1223. If the two or more processor stages include SIMDs, then the SIMDs may have a number of lands of processing equal to the number of lanes of data provided by a vector interconnect of ALN links 1222C-D, and/or 1223.

Each stage in PCU 1320 may also hold one or more registers (not drawn) for short-term storage of parameters. Short-term storage, for example during one to several clock cycles or unit delays, allows for synchronization of data in the PCU pipeline.

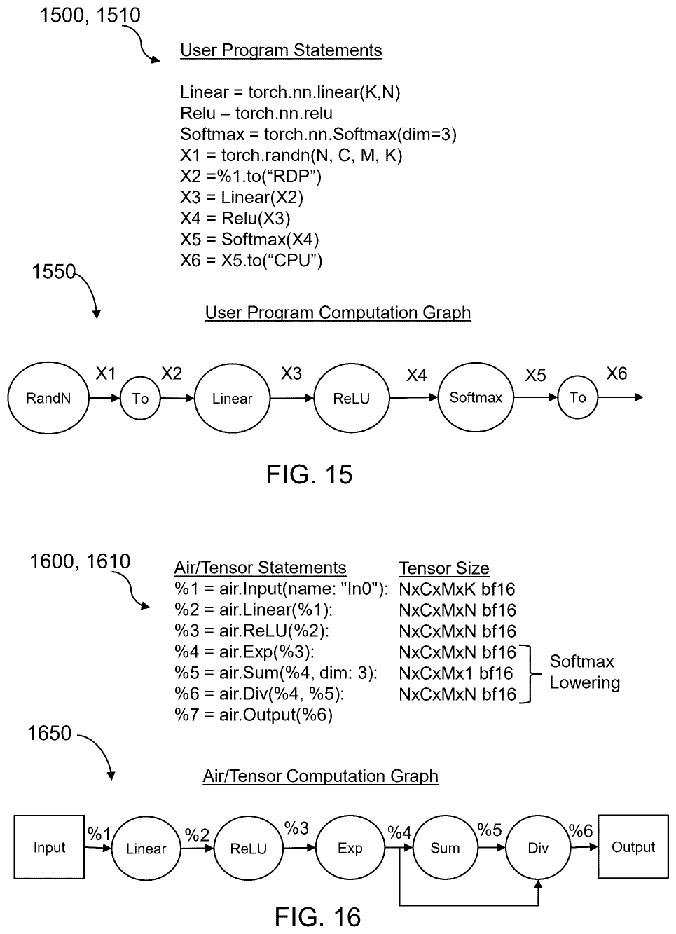

FIG. 14 is a block diagram of a compiler stack 1400 implementation suitable for generating a configuration file for a CGR processor. FIGS. 15-19 illustrate various representations of an example user program 1500 corresponding to various stages of a compiler stack such as compiler stack 1400. As depicted, compiler stack 1400 includes several stages to convert a high-level program (e.g., user program 1500) with statements 1510 that define user algorithms and functions, e.g., algebraic expressions and functions, to configuration data for the CGR units. The example user program 1500 depicted in FIG. 15 comprises statements 1510 that invoke various PyTorch functions.

Compiler stack 1400 may take its input from application platform 1410, or any other source of high-level program statements suitable for parallel processing, which provides a user interface for general users. It may further receive hardware description 1415, for example defining the physical units in a reconfigurable data processor or CGRA processor. Application platform 1410 may include libraries such as PyTorch, TensorFlow, ONNX, Caffe, and Keras to provide user-selected and configured algorithms.

Application platform 1410 outputs a high-level program to compiler 1420, which in turn outputs a configuration file to the reconfigurable data processor or CGRA processor where it is executed in runtime processes 1430. Compiler 1420 may include dataflow graph compiler 1421, which may process a dataflow graph, graphAMP 1422 as described above, algebraic graph compiler 1423, template graph compiler 1424, template library 1425, and placer and router PNR 1426. In some implementations, template library 1425 includes RDU abstract intermediate language (RAIL) and/or assembly language interfaces for power users.

Dataflow graph compiler 1421 converts the high-level program with user algorithms and functions from application platform 1410 to one or more dataflow graphs. The high-level program may be suitable for parallel processing, and therefore parts of the nodes of the dataflow graphs may be intrinsically parallel unless an edge in the graph indicates a dependency. Dataflow graph compiler 1421 may provide code optimization steps like false data dependency elimination, dead-code elimination, and constant folding. The dataflow graphs encode the data and control dependencies of the high-level program. Dataflow graph compiler 1421 may support programming a reconfigurable data processor at higher or lower-level programming languages, for example from an application platform 1410 to C++ and assembly language. In some implementations, dataflow graph compiler 1421 allows programmers to provide code that runs directly on the reconfigurable data processor. In other implementations, dataflow graph compiler 1421 provides one or more libraries that include predefined functions like linear algebra operations, element-wise tensor operations, non-linearities, and reductions required for creating, executing, and profiling the dataflow graphs on the reconfigurable processors. Dataflow graph compiler 1421 may provide an application programming interface (API) to enhance functionality available via the application platform 1410.

GraphAMP 1422 can take a representation of a dataflow graph and convert it to operate with mixed-precision data. In some implementations, graphAMP 1422 may be integrated into the dataflow graph compiler 1421. GraphAMP may convert some edges in the dataflow graph to a lower data precision, such as converting some or all fp32 datatypes to bf16 of fp16 datatypes. The conversion may be performed based on an aggressiveness indication which can be used to assign each node in the dataflow graph to one of an allow set, an infer set, and a deny set. Nodes in the deny set are not converted to a lower data precision. Nodes in the allow set are converted to have at least one of an output, an input, or an internal calculation use a lower data precision. Nodes in the infer set may be converted to use a lower data precision if their output is connected to an input of a node that has been converted to use lower data precision. If an output of a node in the deny set is connected to an input of a node that has been converted to use lower data precision, a conversion node may be inserted by graphAMP to convert the data precision of the node in the deny set to the data precision expected by the input of the converted node.

FIG. 15 shows an example user program 1500 in an example first stage of the compiler stack. User program 1500 generates a random tensor X1 with a normal distribution in the RandN node. It provides the tensor to a neural network cell that performs a weighing function (in the Linear node) followed by a rectified linear unit (ReLU) activation function, which is followed by a Softmax activation function, for example to normalize the output to a probability distribution over a predicted output class. FIG. 15 does not show the weights and bias used for the weighing function. User program 1500 corresponds with computation graph 1550.

Algebraic graph compiler 1423 may include a model analyzer and compiler (MAC) level that makes high-level mapping decisions for (sub-graphs of the) dataflow graph based on hardware constraints. It may support various application frontends such as Samba, JAX, and TensorFlow/HLO. Algebraic graph compiler 1423 may also transform the graphs via autodiff and GradNorm, perform stitching between sub-graphs, interface with template generators for performance and latency estimation, convert dataflow graph operations to AIR operation, perform tiling, sharding (database partitioning) and other operations, and model or estimate the parallelism that can be achieved on the dataflow graphs.

Algebraic graph compiler 1423 may further include an arithmetic or algebraic intermediate representation (AIR) level that translates high-level graph and mapping decisions provided by the MAC level into explicit AIR/Tensor statements 1600 (see FIG. 16) and one or more corresponding algebraic graphs 1650. Key responsibilities of the AIR level include legalizing the graph and mapping decisions of the MAC, expanding data parallel, tiling, metapipe, region instructions provided by the MAC, inserting stage buffers and skip buffers, eliminating redundant operations, buffers, and sections, and optimizing for resource use, latency, and throughput.

FIG. 16 shows the user program 1500 in an example second stage of the compiler stack. At this stage, the algebraic graph compiler replaces the Softmax macro by its constituents. The Softmax function is given as:

$$\frac{{e}^{\{ {z}_{i} \}}}{{\sum }_{j = 1}^{K} {e}^{\{ {z}_{j} \}}} .$$

This function includes an exponential component, a summation, and a division. Thus, algebraic graph compiler 1423 replaces the user program statements 1510, also shown as computation graph 1550, by AIR/Tensor statements 1600, also shown as Air/Tensor computation graph 1650.

Template graph compiler 1424 may translate AIR statements and/or graphs into TLIR statements 1700 (see FIG. 17) and/or graphs (graph 1750 is shown), optimizing for the target hardware architecture into unplaced variable-sized units (referred to as logical CGR units) suitable for PNR 1426. Template graph compiler 1424 may allocate metapipelines, such as metapipeline 1710 and metapipeline 1720, for sections of the template dataflow statements 1700 and corresponding sections of unstitched template computation graph 1750. Template graph compiler 1424 may add further information (name, inputs, input names and dataflow description) for PNR 1426 and make the graph physically realizable through each performed step. Template graph compiler 1424 may for example provide translation of AIR graphs to specific model operation templates such as for general matrix multiplication (GeMM). An implementation may convert part or all intermediate representation operations to templates, stitch templates into the dataflow and control flow, insert necessary buffers and layout transforms, generate test data, and optimize for hardware use, latency, and throughput.

Implementations may use templates for common operations. Templates may be implemented using assembly language, RAIL, or similar. RAIL is comparable to assembly language in that memory units and compute units are separately programmed, but it can provide a higher level of abstraction and compiler intelligence via a concise performance-oriented domain-specific language for CGR array templates. RAIL enables template writers and external power users to control interactions between logical compute units and memory units with high-level expressions without the need to manually program capacity splitting, register allocation, etc. The logical compute units and memory units also enable stage/register allocation, context splitting, transpose slotting, resource virtualization and mapping to multiple physical compute units and memory units (e.g., PCUs and PMUs).

Template library 1425 may include an assembler that provides an architecture-independent low-level programming interface as well as optimization and code generation for the target hardware. Responsibilities of the assembler may include address expression compilation, intra-unit resource allocation and management, making a template graph physically realizable with target-specific rules, low-level architecture-specific transformations and optimizations, and architecture-specific code generation.

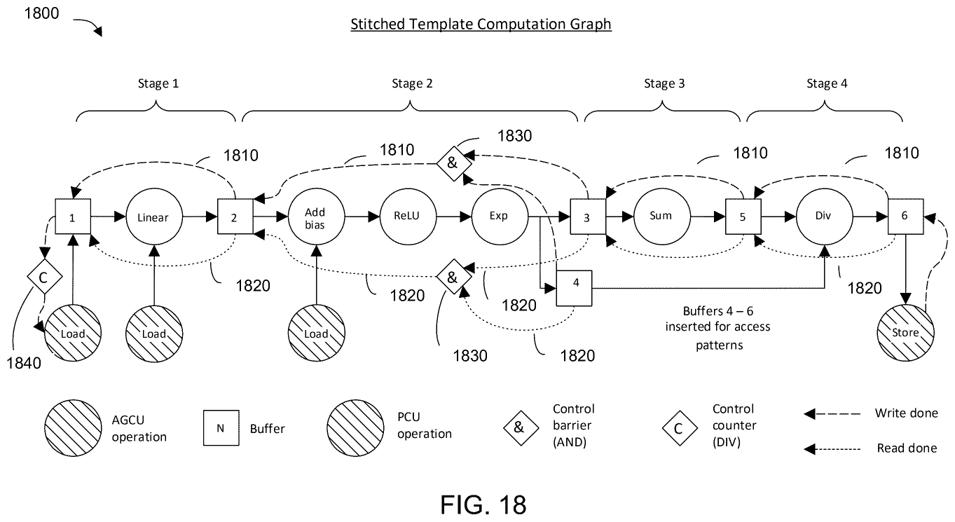

FIG. 18 shows the user program 1500 in an example fourth stage of the compiler stack. The template graph compiler 1424 may also determine the control signals 1810 and 1820, as well as control gates 1830 and 1840 required to enable the CGR units (whether logical or physical) to coordinate dataflow between the CGR units in the CGR array of a CGR processor. This process, sometimes referred to as stitching, produces a stitched template compute graph 1800 with control signals 1810-1820 and control gates 1830-1840. In the example depicted in FIG. 18, the control signals include write done signals 1810 and read done signals 1820, and the control gates include ‘AND’ gates 1830 and a counting or ‘DIV’ gate 1840. The control signals and control gates enable coordinated dataflow between the configurable units of CGR processors such as compute units, memory units, and AGCUs.

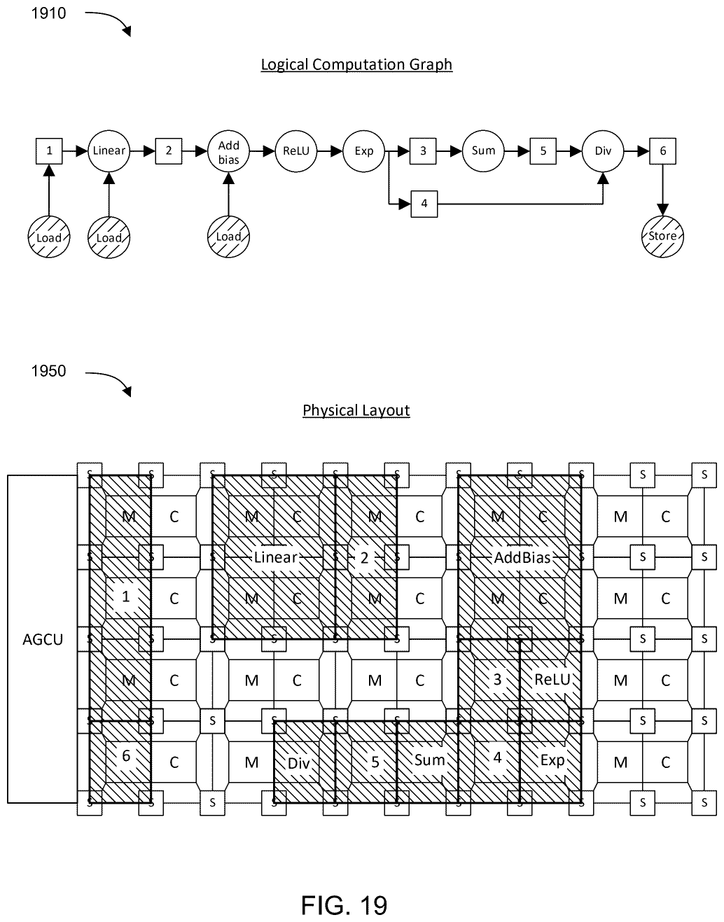

PNR 1426 translates and maps logical (i.e., unplaced physically realizable) CGR units (e.g., the nodes of the logical computation graph 1900 shown in FIG. 19) to a physical layout (e.g., the physical layout 1950 shown in FIG. 19) on the physical level, e.g., a physical array of CGR units in a semiconductor chip. PNR1426 also determines physical data channels to enable communication among the CGR units and between the CGR units and circuits coupled via the TLN; allocates ports on the CGR units and switches; provides configuration data and initialization data for the target hardware; and produces configuration files, e.g., processor-executable format (PEF) files. It may further provide bandwidth calculations, allocate network interfaces such as AGCUs and virtual address generators (VAGs), provide configuration data that allows AGCUs and/or VAGs to perform address translation, and control ALN switches and data routing. PNR 1426 may provide its functionality in multiple steps and may include multiple modules (not shown in FIG. 14) to provide the multiple steps, e.g., a placer, a router, a port allocator, and a PEF file generator. PNR 1426 may receive its input data in numerous ways. For example, it may receive parts of its input data from any of the earlier modules (dataflow graph compiler 1421, algebraic graph compiler 1423, template graph compiler 1424, and/or template library 1425). In some implementations, an earlier module, such as template graph compiler 1424, may have the task of preparing all information for PNR 1426 and no other units provide PNR input data directly.

Further implementations of compiler 1420 provide for an iterative process, for example by feeding information from PNR 1426 back to an earlier module, so that the earlier module can execute a new compilation step in which it uses physically realized results rather than estimates of or placeholders for physically realizable circuits. For example, PNR 1426 may feed information regarding the physically realized circuits back to algebraic graph compiler 1423.

Memory allocations represent the creation of logical memory spaces in on-chip and/or off-chip memories for data required to implement the dataflow graph, and these memory allocations are specified in the configuration file. Memory allocations define the type and the number of hardware circuits (functional units, storage, or connectivity components). Main memory (e.g., DRAM) may be off-chip memory, and scratchpad memory (e.g., SRAM) is on-chip memory inside a CGR array. Other memory types for which the memory allocations can be made for various access patterns and layouts include cache, read-only look-up tables (LUTs), serial memories (e.g., FIFOs), and register files.

Compiler 1420 binds memory allocations to unplaced memory units and binds operations specified by operation nodes in the dataflow graph to unplaced compute units, and these bindings may be specified in the configuration data. In some implementations, compiler 1420 partitions parts of a dataflow graph into memory subgraphs and compute subgraphs and specifies these subgraphs in the PEF file. A memory subgraph may comprise address calculations leading up to a memory access. A compute subgraph may comprise all other operations in the parent graph. In one implementation, a parent graph is broken up into multiple memory subgraphs and exactly one compute subgraph. A single parent graph can produce one or more memory subgraphs, depending on how many memory accesses exist in the original loop body. In cases where the same memory addressing logic is shared across multiple memory accesses, address calculation may be duplicated to create multiple memory subgraphs from the same parent graph.

Compiler 1420 generates the configuration files with configuration data (e.g., a bit stream) for the placed positions and the routed data and control networks. In one implementation, this includes assigning coordinates and communication resources of the physical CGR units by placing and routing unplaced units onto the array of CGR units while maximizing bandwidth and minimizing latency.

FIG. 19 shows the logical computation graph 1900 and an example physical layout 1950 of the user program.

### Particular Implementations

Example 1. A computer-implemented method of transforming a dataflow graph to execute on one or more processors using mixed precision, the method comprising: (a) obtaining, by a computer, an aggressiveness indication and a representation of the dataflow graph including one or more nodes connected by one or more edges having a respective datatype with a respective precision representing dataflow in the dataflow graph; (b) assigning each node of the one or more nodes to one of an allow set, an infer set, or a deny set based on the aggressiveness indication using the computer; (c) traversing, by the computer, the dataflow graph from an output of the dataflow graph to find a node of the one or more nodes in the allow set to select as a target node, the target node having an input with a first datatype at a first data precision; (d) automatically changing the input of the target node to utilize a changed datatype having a changed data precision that is less than the first data precision; (e) identifying, by the computer, a preceding node of the one or more nodes having its output connected to the input of the target node by an edge of the one or more edges; (f) determining a set in which the preceding node is included; (g) in response to determining that the preceding node is in the deny set, automatically inserting a conversion node between the preceding node and the target node to change data of the first datatype provided by the output of the preceding node into the changed datatype having the changed data precision before passing it to the input of the target node; (h) in response to determining that the preceding node is in the allow set or the infer set, automatically changing the preceding node to have the changed datatype for its output, and recursively repeating steps (d) through (h) using the preceding node as the target node; (i) generating a representation of a changed dataflow graph including the changed data precision; and (j) storing the representation of the changed dataflow graph on a non-transitory computer-readable storage medium.

Example 2. The method of example 1, wherein the changed datatype has an equivalent type to the first datatype but with a lower data precision.

Example 3. The method of example 2, wherein a type of the first datatype and the changed datatype comprises a floating-point number type.

Example 4. The method of any of examples 1 through 3, wherein the first datatype is a 32-bit floating-point datatype, and the changed datatype is a 16-bit floating-point datatype.

Example 5. The method of any of examples 1 through 4, wherein the aggressiveness indication is obtained from a user.

Example 6. The method of any of examples 1 through 4, wherein the aggressiveness indication is included in the representation of the dataflow graph.

Example 7. The method of any of examples 1 through 4, wherein the aggressiveness indication is generated based on runtime statistics for the dataflow graph.

Example 8. The method of any of examples 1 through 7, further comprising: obtaining an instance override for an exclusion set of nodes, wherein the exclusion set of nodes is a subset of the one or more nodes; and excluding the exclusion set of nodes from being selected as the target node.

Example 9. The method of example 8, wherein the instance override is obtained from a user.

Example 10. The method of example 8, wherein the instance override is included in the representation of the dataflow graph.

Example 11. The method of any of examples 1 through 10, wherein the target node comprises a multiply operation, the method further comprising: determining that the first data precision is greater than one half of a second data precision of a second datatype of an output of the target node; and changing the first datatype of the input of the target node to have the changed datatype in response to said determining.

Example 12. The method of example 11, wherein the first datatype is encoded using N bits to create the second data precision and the changed datatype is encoded using N/2 bits to create the changed data precision, wherein N is a positive integer.

Example 13. The method of any of examples 1 through 12, further comprising changing at least one of a data precision for an input of the preceding node, or a data precision of an internal calculation of the preceding node.

Example 14. The method of any of examples 1 through 13, further comprising: obtaining, based on the aggressiveness indication, a first list of node functions and a second list of node functions; assigning nodes of the one or more nodes that have a function included in the first list of node functions to the allow set; assigning nodes of the one or more nodes that have a function included in the second list of node functions to the infer set; and assigning nodes of the one or more nodes that have a function not included in either the first list of node functions or the second list of node functions to the deny set.

Example 15. The method of example 14, further comprising: retrieving list S1 as the first list of node functions and list S2 as the second list of node functions in response to the aggressiveness indication having a first semantic meaning, wherein list S1 includes a node function implementing a matrix multiply operation, list S2 is empty, and at least one node of the one or more nodes has a node function that is not in list S1; retrieving list M1 as the first list of node functions and list M2 as the second list of node functions in response to the aggressiveness indication having a second semantic meaning, wherein list M1 includes a node function implementing a matrix multiply operation, list M2 includes a node function implementing a data reorganization operation, and at least one node of the one or more nodes has a node function that is not in list M1 or list M2; and retrieving list L1 as the first list of node functions and list L2 as the second list of node functions in response to the aggressiveness indication having a third semantic meaning, wherein list L1 includes all node functions of the one or more nodes and list L2 is empty.

Example 16. The method of any of examples 1 through 15, the representation of the changed dataflow graph comprising computer instructions for the one or more processors to execute the changed dataflow graph.

Example 17. The method of example 16, further comprising: providing the representation of the changed dataflow graph to a compiler for the one or more processors; generating computer instructions for the one or more processors to execute the changed dataflow graph; and storing the computer instructions on the non-transitory computer-readable storage medium.

Example 18. The method of any of examples 1 through 17, further comprising: reading the computer instructions, by the one or more processors, from the non-transitory computer-readable storage medium; obtaining, by the one or more processors, one or more tensors; and executing the computer instructions to process the one or more tensors as described by the dataflow graph with the changed data precision.

Example 19. The method of example 18, wherein the one or more tensors comprise training data for the dataflow graph.

Example 20. The method of any of examples 1 through 19, further comprising using an output of the dataflow graph with the changed data precision to make a prediction based on the one or more tensors.

Example 21. The method of any of examples 1 through 20, wherein one or more processors comprise a coarse-grained reconfigurable processor.

Example 22. The method of example 1, wherein the representation of the changed dataflow graph comprises first computer instructions for the one or more processors to execute the changed dataflow graph and the aggressiveness indication is a first aggressiveness indication, the method further comprising: obtaining, by the one or more processors, a first set of tensors; executing the first computer instructions to process the first set of tensors; generating runtime statistics for at least a subset of the one or more nodes during the executing of the first computer instructions; automatically determining a second aggressiveness indication based on the runtime statistics; reassigning at least one node of the one or more nodes of the dataflow graph to one of the allow set, the infer set, or the deny set based on the second aggressiveness indication; changing a data precision of an input, an output, and/or an internal calculation of a node of the one or more nodes based on the reassignment to create a second changed dataflow graph; generating second computer instructions for the one or more processors to execute the second changed dataflow graph; and storing the second computer instructions on a non-transitory computer-readable storage medium.

Example 23. A computer-implemented method of transforming a dataflow graph to execute on one or more processors using mixed precision, the method comprising: obtaining a representation of the dataflow graph including one or more nodes connected by one or more edges having a respective datatype with a respective precision representing dataflow in the dataflow graph; evaluating, by a computer, the dataflow graph to select a target node of the one or more nodes for data precision adjustment, the target node having an input with a first datatype at a first data precision; automatically changing at least one of the first datatype, a second datatype of an output of the target node, or a third datatype of an internal calculation of the target node, to a changed datatype at a changed data precision; generating a representation of a changed dataflow graph including the changed data precision using the computer; and storing the representation of the changed dataflow graph on a non-transitory computer-readable storage medium.

Example 24. The method of example 23, wherein the first datatype is changed to the changed datatype and the changed data precision is less than the first data precision.

Example 25. The method of example 24, wherein the first datatype is equal to the second datatype and the changed datatype has an equivalent type to the first datatype but with a lower data precision.

Example 26. The method of example 25, wherein a type of the first datatype, the second datatype, and the changed datatype comprises a floating-point number type.

Example 27. The method of any of examples 23 through 26, wherein the first datatype and the second datatype are a 32-bit floating-point datatype, and the changed datatype is a 16-bit floating-point datatype.

Example 28. The method of any of examples 23 through 27, further comprising: obtaining an instance override for an exclusion set of nodes, wherein the exclusion set of nodes is a subset of the one or more nodes; and excluding the exclusion set of nodes from being selected as the target node.

Example 29. The method of example 28, wherein the instance override is obtained from a user.

Example 30. The method of example 28, wherein the instance override is included in the representation of the dataflow graph.

Example 31. The method of any of examples 23 through 30, further comprising: obtaining an aggressiveness indication for the dataflow graph; and selecting the target node based on the aggressiveness indication.

Example 32. The method of example 31, wherein the aggressiveness indication identifies a node function for changing precision, and the target node is selected based on the node function.

Example 33. The method of example 31 or 32, wherein the aggressiveness indication is obtained from a user.

Example 34. The method of example 31 or 32, wherein the aggressiveness indication is included in the representation of the dataflow graph.

Example 35. The method of example 31 or 32, wherein the aggressiveness indication is generated based on runtime statistics for the dataflow graph.

Example 36. The method of any of examples 23 through 35, wherein the target node comprises a multiply operation, the method further comprising: determining that the first data precision is greater than one half of a second data precision of the second datatype; and changing the first datatype of the input of the target node to have the changed datatype in response to said determining, wherein the changed data precision is lower than the second data precision.

Example 37. The method of example 36, wherein the first datatype is encoded using N bits to create the second data precision and the changed datatype is encoded using N/2 bits to create the changed data precision, wherein N is a positive integer.

Example 38. The method of any of examples 23 through 37, further comprising: changing the first data precision of the input of the target node to the changed data precision; selecting a preceding node of the one or more nodes having its output connected to the input of the target node by an edge of the one or more edges; and inserting a conversion node between the preceding node and the target node to change a precision of data provided by the output of the preceding node having the first data precision to the changed data precision before passing it to the input of the target node.

Example 39. The method of any of examples 23 through 38, further comprising: changing the first data precision of the input of the target node to the changed data precision; identifying a preceding node of the one or more nodes having its output connected to the input of the target node by an edge of the one or more edges; determining that the preceding node is eligible for data precision adjustment; and changing, based on the changed data precision of the input of the target node, an output data precision of the preceding node.

Example 40. The method of example 39, further comprising changing at least one of a data precision for an input of the preceding node, or a data precision of an internal calculation of the preceding node.

Example 41. The method of example 39 or 40, further comprising: obtaining an aggressiveness indication for the dataflow graph; and determining that the preceding node is eligible for data precision adjustment based on the aggressiveness indication.

Example 42. The method of any of examples 23 through 41, further comprising: assigning each node of the one or more nodes to one of an allow set, an infer set, or a deny set; and selecting the target node from the allow set.

Example 43. The method of example 42, further comprising: changing the first data precision of the input of the target node to the changed data precision; identifying a preceding node of the one or more nodes having its output connected to the input of the target node by an edge of the one or more edges; determining that the preceding node is in the allow set or the infer set; and changing, based on the changed data precision of the input of the target node, an output data precision of the preceding node.

Example 44. The method of example 43, further comprising changing at least one of a data precision for an input of the preceding node, or a data precision of an internal calculation of the preceding node.

Example 45. The method of example 42, further comprising: changing the first data precision of the input of the target node to the changed data precision; identifying a preceding node of the one or more nodes having its output connected to the input of the target node by an edge of the one or more edges; determining that the preceding node is in the deny set; and inserting a conversion node between the preceding node and the target node to change a precision of data provided by the output of the preceding node having the first data precision to the changed data precision before passing it to the input of the target node.

Example 46. The method of any of examples 23 through 45, further comprising obtaining an aggressiveness indication for the dataflow graph, wherein said assigning is done based on the aggressiveness indication.

Example 47. The method of example 46, further comprising: obtaining, based on the aggressiveness indication, a first list of node functions and a second list of node functions; assigning nodes of the one or more nodes that have a function included in the first list of node functions to the allow set; assigning nodes of the one or more nodes that have a function included in the second list of node functions to the infer set; and assigning nodes of the one or more nodes that have a function not included in either the first list of node functions or the second list of node functions to the deny set.

Example 48. The method of example 47, further comprising: retrieving list S1 as the first list of node functions and list S2 as the second list of node functions in response to the aggressiveness indication having a first semantic meaning, wherein list S1 includes a node function implementing a matrix multiply operation, list S2 is empty, and at least one node of the one or more nodes has a node function that is not in list S1; retrieving list M1 as the first list of node functions and list M2 as the second list of node functions in response to the aggressiveness indication having a second semantic meaning, wherein list M1 includes a node function implementing a matrix multiply operation, list M2 includes a node function implementing a data reorganization operation, and at least one node of the one or more nodes has a node function that is not in list M1 or list M2; and retrieving list L1 as the first list of node functions and list L2 as the second list of node functions in response to the aggressiveness indication having a third semantic meaning, wherein list L1 includes all node functions of the one or more nodes and list L2 is empty.

Example 49. The method of any of examples 23 through 48, the representation of the changed dataflow graph comprising computer instructions for the one or more processors to execute the changed dataflow graph.

Example 50. The method of any of examples 23 through 49, further comprising: providing the representation of the changed dataflow graph to a compiler for the one or more processors; generating computer instructions for the one or more processors to execute the changed dataflow graph; and storing the computer instructions on the non-transitory computer-readable storage medium.

Example 51. The method of any of examples 23 through 50, wherein the representation of the changed dataflow graph comprises computer instructions for the one or more processors to execute the changed dataflow graph, the method further comprising: reading the computer instructions, by the one or more processors, from the non-transitory computer-readable storage medium; obtaining, by the one or more processors, one or more tensors; and executing the computer instructions to process the one or more tensors as described by the dataflow graph with the changed data precision.

Example 52. The method of example 51, wherein the one or more tensors comprise training data for the dataflow graph.

Example 53. The method of example 51 or 52, further comprising using an output of the dataflow graph with the changed data precision to make a prediction based on the one or more tensors.

Example 54. The method of any of examples 23 through 53, wherein one or more processors comprise a coarse-grained reconfigurable processor.

Example 55. The method of any of examples 23 through 54, wherein the representation of the changed dataflow graph comprises second computer instructions for the one or more processors to execute the changed dataflow graph, the method further comprising: generating first computer instructions for the one or more processors to execute the dataflow graph as defined by the representation of the dataflow graph; obtaining, by the one or more processors, a first set of tensors; executing the first computer instructions to process the first set of tensors; generating runtime statistics for at least a subset of the one or more nodes during the executing of the first computer instructions; selecting the target node based on the runtime statistics; obtaining, by the one or more processors, a second set of tensors; and executing the second computer instructions to process the second set of tensors using the changed data precision.

Example 56. The method of any of examples 23 through 55, further comprising: obtaining a representation of a cyclic directed graph; breaking the cyclic directed graph into one or more acyclic subgraphs; and using an acyclic subgraphs of the one or more acyclic subgraphs as the dataflow graph.

Example 57. The method of any of examples 23 through 56, wherein boundaries of the dataflow graph are edges of the one or more edges.

Example 58. An article of manufacture comprising a computer readable storage medium having computer usable program code embodied therewith, wherein the program code, when loaded into one or more computers, cause the one or more computers to perform a method comprising: obtaining a representation of a dataflow graph including one or more nodes connected by one or more edges having a respective datatype with a respective precision representing dataflow in the dataflow graph; evaluating the dataflow graph to select a target node of the one or more nodes for data precision adjustment, the target node having an input with a first datatype at a first data precision; changing at least one of the first datatype, a second datatype of an output of the target node, or a third datatype of an internal calculation of the target node, to a changed datatype at a changed data precision; generating a representation of a changed dataflow graph including the changed data precision; and storing the representation of the changed dataflow graph on a non-transitory computer-readable storage medium.

Example 59. An article of manufacture comprising a computer readable storage medium having computer usable program code embodied therewith, wherein the program code, when loaded into one or more computers, cause the one or more computers to perform any one of the methods of examples 1 through 57.

A first example of accelerated deep learning is using a deep learning accelerator implemented in a CGRA to train a neural network. A second example of accelerated deep learning is using the deep learning accelerator to operate a trained neural network to perform inferences. A third example of accelerated deep learning is using the deep learning accelerator to train a neural network and subsequently perform inference with any one or more of the trained neural network, information from the trained neural network, and a variant of the same.

Examples of neural networks include fully connected neural networks (FCNNs), recurrent neural networks (RNNs), graph neural networks (GNNs), convolutional neural networks (CNNs), graph convolutional networks (GCNs), long short-term memory (LSTM) networks, autoencoders, deep belief networks, and generative adversarial networks (GANs).

An example of training a neural network is determining one or more weights associated with the neural network, such as by back-propagation in a deep learning accelerator. An example of making an inference is using a trained neural network to compute results by processing input data using the weights associated with the trained neural network. As used herein, the term ‘weight’ is an example of a ‘parameter’ as used in various forms of neural network processing. For example, some neural network learning is directed to determining parameters (e.g., through back-propagation) that are usable for performing neural network inferences.

A neural network processes data according to a dataflow graph comprising layers of neurons. Example layers of neurons include input layers, hidden layers, and output layers. Stimuli (e.g., input data) are received by an input layer of neurons and the computed results of the dataflow graph (e.g., output data) are provided by an output layer of neurons. Example hidden layers include rectified linear unit (ReLU) layers, fully connected layers, recurrent layers, graphical network layers, long short-term memory layers, convolutional layers, kernel layers, dropout layers, and pooling layers. A neural network may be conditionally and/or selectively trained. After being trained, a neural network may be conditionally and/or selectively used for inference.

Examples of ICs, or parts of ICs, that may be used as deep learning accelerators, are processors such as central processing unit (CPUs), CGR processor ICs, graphics processing units (GPUS), FPGAS, ASICS, application-specific instruction-set processor (ASIP), and digital signal processors (DSPs). The disclosed technology implements efficient distributed computing by allowing an array of accelerators (e.g., reconfigurable processors) attached to separate hosts to directly communicate with each other via buffers.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the implementations described herein.

Although the description has been described with respect to particular implementations thereof, these particular implementations are merely illustrative, and not restrictive. The description may reference specific structural implementations and methods and does not intend to limit the technology to the specifically disclosed implementations and methods. The technology may be practiced using other features, elements, methods, and implementations. Implementations are described to illustrate the present technology, not to limit its scope, which is defined by the claims. Those of ordinary skill in the art recognize a variety of equivalent variations of the description above.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to specific implementations thereof, these specific implementations are merely illustrative, and not restrictive. For instance, many of the operations can be implemented on a printed circuit board (PCB) using off-the-shelf devices, in a System-on-Chip (SoC), application-specific integrated circuit (ASIC), programmable processor, a coarse-grained reconfigurable architecture (CGRA), or in a programmable logic device such as a field-programmable gate array (FPGA), obviating the need for at least part of any dedicated hardware. Implementations may be as a single chip, or as a multi-chip module (MCM) packaging multiple semiconductor dies in a single package. All such variations and modifications are to be considered within the ambit of the disclosed technology the nature of which is to be determined from the foregoing description.

Any suitable technology for manufacturing electronic devices can be used to implement the circuits of specific implementations, including CMOS, FinFET, GAAFET, BICMOS, bipolar, JFET, MOS, NMOS, PMOS, HBT, MESFET, etc. Different semiconductor materials can be employed, such as silicon, germanium, SiGe, GaAs, InP, GaN, SiC, graphene, and the like. Circuits may have single-ended or differential inputs, and single-ended or differential outputs. Terminals to circuits may function as inputs, outputs, both, or be in a high-impedance state, or they may function to receive supply power, a ground reference, a reference voltage, a reference current, or other. Although the physical processing of signals may be presented in a specific order, this order may be changed in different specific implementations. In some specific implementations, multiple elements, devices, or circuits shown as sequential in this specification can be operated in parallel.

Any suitable programming language can be used to implement the routines of specific implementations including C, C++, Java, JavaScript, compiled languages, interpreted languages and scripts, assembly language, machine language, etc. Different programming techniques can be employed such as procedural or object oriented. Methods embodied in routines can be executed on a single processor device or on a multiple processor system. Although the steps, operations, or computations may be presented in a specific order, this order may be changed in different specific implementations. In some specific implementations, multiple steps shown as sequential in this specification can be performed at the same time.

Specific implementations may be implemented in a tangible, non-transitory computer-readable storage medium for use by or in connection with the instruction execution system, apparatus, board, or device. Specific implementations can be implemented in the form of control logic in software or hardware or a combination of both. The control logic, when executed by one or more processors, may be operable to perform that which is described in specific implementations. For example, a tangible non-transitory medium such as a hardware storage device can be used to store the control logic, which can include executable instructions.

One or more implementations of the technology or elements thereof can be implemented in the form of a computer product, including a non-transitory computer-readable storage medium with computer usable program code, such as computer instructions of configuration files, for performing any indicated method steps and/or any configuration file for one or more CGR processors to execute a high-level program. Furthermore, one or more implementations of the technology or elements thereof can be implemented in the form of an apparatus including a memory and at least one processor that is coupled to the memory and operative to perform exemplary method steps, and/or a CGR processor that is operative to execute a high-level program based on a configuration file. Yet further, in another aspect, one or more implementations of the technology or elements thereof can be implemented in the form of means for performing one or more of the method steps described herein and/or executing a high-level program described herein. Such means can include (i) hardware module(s); (ii) software module(s) executing on one or more hardware processors; (iii) bit files for configuration of a CGR array; or (iv) a combination of aforementioned items.

It will also be appreciated that one or more of the elements depicted in the drawings/figures can also be implemented in a more separated or integrated manner, or even removed or rendered as inoperable in certain cases, as is useful in accordance with a particular application.

Thus, while specific implementations have been described herein, latitudes of modification, various changes, and substitutions are intended in the foregoing disclosures, and it will be appreciated that in some instances some features of specific implementations will be employed without a corresponding use of other features without departing from the scope and spirit as set forth. Therefore, many modifications may be made to adapt a particular situation or material while maintaining the scope of the disclosure.

What is claimed is:

1. A computer-implemented method of transforming a dataflow graph to execute on one or more processors using mixed precision, the method comprising:
(a) obtaining, by a computer, an aggressiveness indication and a representation of the dataflow graph including one or more nodes connected by one or more edges having a respective datatype with a respective precision representing dataflow in the dataflow graph;
(b) assigning each node of the one or more nodes to one of an allow set, an infer set, or a deny set based on the aggressiveness indication using the computer;
(c) traversing, by the computer, the dataflow graph from an output of the dataflow graph to find a node of the one or more nodes in the allow set to select as a target node, the target node having an input with a first datatype at a first data precision;
(d) automatically changing the input of the target node to utilize a changed datatype having a changed data precision that is less than the first data precision;
(e) identifying, by the computer, a preceding node of the one or more nodes having its output connected to the input of the target node by an edge of the one or more edges;
(f) determining a set in which the preceding node is included;
(g) in response to determining that the preceding node is in the deny set, automatically inserting a conversion node between the preceding node and the target node to change data of the first datatype provided by the output of the preceding node into the changed datatype having the changed data precision before passing it to the input of the target node;
(h) in response to determining that the preceding node is in the allow set or the infer set, automatically changing the preceding node to have the changed datatype for its output, and recursively repeating steps (d) through (h) using the preceding node as the target node;
(i) generating a representation of a changed dataflow graph including the changed data precision; and
(j) storing the representation of the changed dataflow graph on a non-transitory computer-readable storage medium.

2. The method of claim 1, wherein the representation of the changed dataflow graph comprises first computer instructions for the one or more processors to execute the changed dataflow graph and the aggressiveness indication is a first aggressiveness indication, the method further comprising:
obtaining, by the one or more processors, a first set of tensors;
executing the first computer instructions to process the first set of tensors;
generating runtime statistics for at least a subset of the one or more nodes during the executing of the first computer instructions;
automatically determining a second aggressiveness indication based on the runtime statistics;
reassigning at least one node of the one or more nodes of the dataflow graph to one of the allow set, the infer set, or the deny set based on the second aggressiveness indication;
changing a data precision of an input, an output, and/or an internal calculation of a node of the one or more nodes based on the reassignment to create a second changed dataflow graph;
generating second computer instructions for the one or more processors to execute the second changed dataflow graph; and
storing the second computer instructions on a non-transitory computer-readable storage medium.

3. A computer-implemented method of transforming a dataflow graph to execute on one or more processors using mixed precision, the method comprising:
obtaining a representation of the dataflow graph including one or more nodes connected by one or more edges having a respective datatype with a respective precision representing dataflow in the dataflow graph;
evaluating, by a computer, the dataflow graph to select a target node of the one or more nodes for data precision adjustment, the target node having an input with a first datatype at a first data precision;
automatically changing at least one of the first datatype, a second datatype of an output of the target node, or a third datatype of an internal calculation of the target node, to a changed datatype at a changed data precision;
generating a representation of a changed dataflow graph including the changed data precision using the computer; and
storing the representation of the changed dataflow graph on a non-transitory computer-readable storage medium.

4. The method of claim 3, further comprising:
obtaining an instance override for an exclusion set of nodes, wherein the exclusion set of nodes is a subset of the one or more nodes; and
excluding the exclusion set of nodes from being selected as the target node.

5. The method of claim 3, further comprising:
obtaining an aggressiveness indication for the dataflow graph; and
selecting the target node based on the aggressiveness indication.

6. The method of claim 3, wherein the target node comprises a multiply operation, the method further comprising:
determining that the first data precision is greater than one half of a second data precision of the second datatype; and
changing the first datatype of the input of the target node to have the changed datatype in response to said determining, wherein the changed data precision is lower than the second data precision.

7. The method of claim 3, further comprising:
changing the first data precision of the input of the target node to the changed data precision;
selecting a preceding node of the one or more nodes having its output connected to the input of the target node by an edge of the one or more edges; and
inserting a conversion node between the preceding node and the target node to change a precision of data provided by the output of the preceding node having the first data precision to the changed data precision before passing it to the input of the target node.

8. The method of claim 3, further comprising:
changing the first data precision of the input of the target node to the changed data precision;
identifying a preceding node of the one or more nodes having its output connected to the input of the target node by an edge of the one or more edges;
determining that the preceding node is eligible for data precision adjustment; and
changing, based on the changed data precision of the input of the target node, an output data precision of the preceding node.

9. The method of claim 8, further comprising changing at least one of a data precision for an input of the preceding node, or a data precision of an internal calculation of the preceding node.

10. The method of claim 3, further comprising:
assigning each node of the one or more nodes to one of an allow set, an infer set, or a deny set; and
selecting the target node from the allow set.

11. The method of claim 10, further comprising:
changing the first data precision of the input of the target node to the changed data precision;
identifying a preceding node of the one or more nodes having its output connected to the input of the target node by an edge of the one or more edges;
determining that the preceding node is in the allow set or the infer set; and
changing, based on the changed data precision of the input of the target node, an output data precision of the preceding node.

12. The method of claim 10, further comprising:
changing the first data precision of the input of the target node to the changed data precision;
identifying a preceding node of the one or more nodes having its output connected to the input of the target node by an edge of the one or more edges;
determining that the preceding node is in the deny set; and
inserting a conversion node between the preceding node and the target node to change a precision of data provided by the output of the preceding node having the first data precision to the changed data precision before passing it to the input of the target node.

13. The method of claim 10, further comprising:
obtaining an aggressiveness indication for the dataflow graph, wherein said assigning is done based on the aggressiveness indication;
obtaining, based on the aggressiveness indication, a first list of node functions and a second list of node functions;
assigning nodes of the one or more nodes that have a function included in the first list of node functions to the allow set;
assigning nodes of the one or more nodes that have a function included in the second list of node functions to the infer set; and
assigning nodes of the one or more nodes that have a function not included in either the first list of node functions or the second list of node functions to the deny set.

14. The method of claim 3, wherein the representation of the changed dataflow graph comprises computer instructions for the one or more processors to execute the changed dataflow graph, the method further comprising:
reading the computer instructions, by the one or more processors, from the non-transitory computer-readable storage medium;
obtaining, by the one or more processors, one or more tensors; and
executing the computer instructions to process the one or more tensors as described by the dataflow graph with the changed data precision.

15. The method of claim 14, wherein the one or more tensors comprise training data for the dataflow graph.

16. The method of claim 14, further comprising using an output of the dataflow graph with the changed data precision to make a prediction based on the one or more tensors.

17. The method of claim 14, wherein one or more processors comprise a coarse-grained reconfigurable processor.

18. The method of claim 3, wherein the representation of the changed dataflow graph comprises second computer instructions for the one or more processors to execute the changed dataflow graph, the method further comprising:
generating first computer instructions for the one or more processors to execute the dataflow graph as defined by the representation of the dataflow graph;
obtaining, by the one or more processors, a first set of tensors;
executing the first computer instructions to process the first set of tensors;
generating runtime statistics for at least a subset of the one or more nodes during the executing of the first computer instructions;
selecting the target node based on the runtime statistics;
obtaining, by the one or more processors, a second set of tensors; and
executing the second computer instructions to process the second set of tensors using the changed data precision.

19. The method of claim 3, further comprising:
obtaining a representation of a cyclic directed graph;
breaking the cyclic directed graph into one or more acyclic subgraphs; and
using an acyclic subgraph of the one or more acyclic subgraphs as the dataflow graph.

20. An article of manufacture comprising a computer readable storage medium having computer usable program code embodied therewith, wherein the program code, when loaded into one or more computers, cause the one or more computers to perform a method comprising:
obtaining a representation of a dataflow graph including one or more nodes connected by one or more edges having a respective datatype with a respective precision representing dataflow in the dataflow graph;
evaluating the dataflow graph to select a target node of the one or more nodes for data precision adjustment, the target node having an input with a first datatype at a first data precision;
changing at least one of the first datatype, a second datatype of an output of the target node, or a third datatype of an internal calculation of the target node, to a changed datatype at a changed data precision;
generating a representation of a changed dataflow graph including the changed data precision; and
storing the representation of the changed dataflow graph on a non-transitory computer-readable storage medium.
